(19) United States
(12) Patent Application Publication
(10) Pub. No.: US 2007/0157251 A1
(43) Pub. Date: Jul. 5, 2007

(54) Methods and Systems For Distributing Assets Associated With Television Program

(75) Inventors: Nimish SHRIVASTAVA, San Marcos, CA (US); Jatin DESAI, Duluth, GA (US); Vibha RUSTAGI, Duluth, GA (US); Jaspal BHASIN, Duluth, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: MPTV, LLC, Duluth, GA (US)

(21) Appl. No.: 11/619,440

(22) Filed: Jan. 3, 2007

Related U.S. Application Data
(60) Provisional application No. 60/766,244, filed on Jan. 4, 2006.

(51) Int. Cl. H04N 7/18; H04N 7/173; H04N 5/445; G06F 3/00; G06F 13/00

(52) U.S. Cl. 725/60; 725/61; 725/100; 725/131; 725/81

(57) ABSTRACT

Systems and methods for on-demand purchasing and distribution of products associated with a television program (“assets”) to consumers, such as music, telephone ringtones, videos, CDs, DVDs, coupons, and other products. An asset tag insertion system inserts an asset tag into a television signal; the asset tag identifies an asset associated with a television program represented by the television signal. A settop box program is responsive to an asset tag contained in a television signal for extracting the asset tag and displaying information corresponding to the asset tag to a viewer. The settop box program is further responsive to a command from the viewer for a purchase or other transaction involving the asset, for generating an order command corresponding to an order for the asset. The settop box program is further responsive to communicate the order command to an order management system, which delivers the asset to the purchaser.

The present invention relates generally to on-demand purchasing of products associated with a television program, and more particularly relates to methods and systems for distributing products associated with a television program (“assets”) to consumers such as music, telephone ringtones, videos, CDs, DVDs, and other products that might be associated with the television program.

Modern consumers are presented with myriad opportunities to enjoy a wide variety of television (TV) programs delivered by broadcast, cable, and satellite. Currently popular programs provided by television networks include reality TV shows, cartoons, sit-coms, standup comedy, advertisements, musical concerts, theatre, movies, and on and on. The popularity of many of these programs has led to a consumer demand for products that are associated with a particular TV program, such as a cellphone ringtone of a popular song, or a music video of a popular artist's live performance, or a DVD of an entire season's episodes of a program. These associated products may be provided in many various forms, such as mobile telephone (cellphone) ringtones, video clips, music downloads for replay (on personal computers, MP3 players, APPLE iPods, cellphones, etc.), and various other forms of digital as well as non-digital (regular) media including collectibles, posters, books, magazines, and the like.

Despite the demand for such associated products, it has proven difficult to conveniently offer TV program related assets to consumers in a manner that is quick and convenient. Often, a consumer viewing a commercial on TV for a product will not have a pencil or pen handy to write down a “1-800” telephone number, or will not have an Internet-connected computer at hand to order from the web, or will not have a credit card handy to use for ordering. The consumer, due to “couch inertia,” may simply elect to continue watching the program and decline to take action to obtain an associated product. A convenient sales mechanism might satisfy the immediate demand and provide a market opportunity for the program's producer, as well for advertisers on the program in commercial television. Such a sales system for associated assets would need to be handy, convenient, and immediately accessible. Such systems do not exist in present day television program distribution systems, despite the sophistication of modern cable television and satellite broadcast systems with programmable set-top boxes and two-way (upstream and downstream) communication channels.

One currently popular product that is amenable to use of a TV program related product is the mobile phone or cellphone. Many modern cellphones have capability to install various different sounds as ringtones, or play video clips, or play music such as MP3s. In 2004, the number of mobile phone subscribers grew to 180 million in the United States alone. Advanced technologies have made mobile devices smarter and capable of doing much more than those of merely a few years ago. Some mobile devices now include the function of a web browser, an MP3 player, an audio/video player, video games, online games, SMS text messaging, etc. In addition, mobile devices are often programmed to allow viewers to customize and individualize the device's ringtones. Melodies, human voices, notes of birds, and other sounds can be used as ringtones of mobile phones. These ringtones can be either stored in the mobile devices by the original manufacturer of the mobile devices, or downloaded from ringtone providers. The downloading of ringtones of a typical duration of 10-20 seconds has recently grown into a multi-million dollar business.

The broadcasting or downloading of digital video to mobile phones is seen as the next wave of new applications on mobile devices. Many mobile devices for third-generation (3G) mobile communication networks are already in the market. The high speed downloading capability of 3G networks provides new opportunities for downloading and playing audio and video clips. There are two types of mobile video content services: downloadable and streaming. A consumer can download from a network, store, and play back videos on his/her mobile device. Or, the consumer can stream video content from a network, which may be a better option for viewing longer clips because data is not stored on the mobile device. The consumer can also tune in to live video feeds using streaming. Several mobile communication service providers are offering downloading and/or streaming of video clips such as music performances and news programs to mobile phones.

Some systems for distributing digital content to consumers are known in the art. U.S. Pat. No. 6,904,264 to Frantz describes a method for requesting and paying for downloaded digital radio content. A listener to a digital radio transmission through a digital receiver may transmit a request to download selected content to a content agent. An authorizing entity is responsible for authorizing the downloading of the digital content. If the content is not free of charge, the listener is required to transmit information to allow for payment for the content. The listener then receives a transmission authorizing the downloading of the digital content from the content agent upon acceptance of the payment by the content agent. The listener then downloads the content to a storage device that is coupled to the receiver. This system is limited to the digital radio transmission. The digital radio transmission does not contain many media types such as video clips, animations, soap opera episodes, etc.

U.S. Published Pat. App. No. 20050246193 to Roever et al. describes methods and apparatus for enabling transactions relating to digital assets. The system described in the application enables transactions in electronic networks relating to digital assets, e.g., digital goods or services, through the use of title objects. A title object may have a number of elements and attributes that identify one or more digital assets and define access rights to the corresponding digital asset(s). These methods are not readily implemented in wireless communication networks and are not readily adaptable to the contents that a cable television system can offer.

Therefore, a need exists in the art for a comprehensive system that exposes consumers viewing a TV program to the opportunity to easily obtain an asset associated with the program watched, for example, to recognize that an asset associated with a television show is being offered (such as a segment of sound or music, or a video clip, or a ringtone, or another type of asset), conveniently order the offered asset, pay for the purchase through existing equipment such as the cable television system via an attached set-top box or the mobile phone bill, and receive the asset through some form of delivery network.

As will be described and explained in detail below, the present inventors have constructed various systems and methods for ordering and delivery of television program related assets through a cable television system, including direct delivery to a mobile device such as a cellphone, or other forms of delivery.

### SUMMARY OF THE INVENTION

Briefly described, and according to one aspect, the present invention relates to systems and methods for ordering and delivery of television program related assets through a cable television system, including direct delivery to a mobile device such as a cellphone, as well as other forms of delivery.

In one aspect, the present invention relates to a system and method for delivering an asset associated with a television program to a viewer of the program. In one embodiment, the system comprises: a asset tag insertion system for inserting an asset tag corresponding to an available asset into a television signal for delivery to a viewer, a program for a settop box responsive to an asset tag contained in a television signal for extracting the asset tag, displaying the asset tag to the viewer, receiving a command from the viewer for purchase or other transaction involving the asset, generating an order command for purchase or other transaction involving the asset, and communicating the order command to an order management system, an order management system responsive to an order command from a settop box for generating an order for the asset and communicating the order to a content mapping, distribution, and billing system, and a content mapping, distribution, and billing system responsive to the order for the asset for making arrangements for delivery of the asset to a destination specified by the requesting viewer and for generating a billing transaction associated with the purchase and/or delivery of the asset.

In another aspect, the present invention relates to a system for ordering and delivering assets associated with a television program represented by a television signal received by a settop box and converted into a form for display to a viewer. In one embodiment, the system comprises: an asset tag insertion system and a settop box program. The asset tag insertion system is used for inserting an asset tag into a television signal (digital or analog), the asset tag identifying an asset associated with a television program represented by the television system, the asset being available for purchase or other transaction. The functionalities of the settop box program include: extracting the asset tag contained in the television signal and displaying (information corresponding to) the asset tag to a viewer, responsive to a command from the viewer for purchase or other transaction involving the asset for generating an order command corresponding to an order for the asset, and further responsive to communicate the order command to an order management system. The assets are selected from the group comprising: digital sound in MP3 format, digital sound in other format, digital video, telephone ringtones, books, CDs, DVDs, coupons, wallpapers, skins, coupons and games.

In yet another aspect, the present invention relates to a system and method for associating an asset tag corresponding to an asset associated with a television program that is available for purchase or other transaction, with a television program guide, so that a viewer of the television program is exposed to available assets upon viewing the program and can conduct a transaction involving the asset. The system comprises: an asset store for storing asset tag information associated with assets that in turn are associated with a television program, a program guide store for storing schedule information corresponding to scheduled times for communication of programs having assets associated therewith, an asset tag insertion component responsive to schedule information in the program guide store for retrieving tag information from the asset store and inserting the tag information into a television signal corresponding to a communicated program at a scheduled time, and an output for communicating the combined television signal and asset tag to a settop box for viewing and possible purchase or other transaction.

These and other aspects, features, and benefits of the present invention(s) will become apparent from the following detailed written description of the preferred embodiments taken in conjunction with the following drawings, although variations and modifications therein may be affected without departing from the spirit and scope of the novel concepts of the disclosure.

### BRIEF DESCRIPTION OF THE DRAWING FIGURES

FIG. 1 is an overview of an exemplary system for distributing digital media in cable broadcasting environment according to one embodiment of the present invention.

FIG. 2 is a system overview of an exemplary system for distributing digital media in cable broadcasting environment according to one embodiment of the present invention.

FIG. 3A overview of asset tag insertion through content sources according to one embodiment of the present invention.

FIG. 3B overview of asset tag insertion through cable system headend with content with synchronous asset tags according to one embodiment of the present invention.

FIG. 3C overview of asset tag insertion through cable system headend with content and separate asynchronously downloaded asset tags according to one embodiment of the present invention.

FIG. 4 shows an overview of an exemplary settop application according to one embodiment of the present invention.

FIG. 5 is a flowchart for an Asset Tag Module of settop application finding asset tag data from an audio/video stream according to one embodiment of the present invention.

FIG. 6 is a flowchart for an Asset Tag Module of settop application finding asset tag data by association of channel/time according to one embodiment of the present invention.

FIG. 7 is a flowchart for an Asset Tag Module of settop application periodically downloading asset tag schedule according to one embodiment of the present invention.

FIG. 8 is a flowchart for a User Interface Module interacting with a viewer while the viewer is making a purchase according to one embodiment of the present invention.

FIG. 9 is a flowchart for an Order Module of settop application providing asset details to User Interface Module according to one embodiment of the present invention.

FIG. 10 is a flowchart for an Order Module of settop application processing an order according to one embodiment of the present invention.

FIG. 11 is a flowchart for an Order Module of settop application retrieving asset details in bulk according to one embodiment of the present invention.

FIG. 12 is a flowchart for an Order Management Module of an Order Management System processing an order according to one embodiment of the present invention.

FIG. 13 is a flowchart for a Tag Information Module of an Order Management System providing asset details to settop applications according to one embodiment of the present invention.

FIG. 14 is a flowchart for an Order Management System caching asset tag schedule and inserting tags in an audio/video stream according to one embodiment of the present invention.

FIG. 15 is a block diagram for a Content Mapping, Distribution and Billing system according to one embodiment of the present invention.

FIG. 16 is a flowchart for a Content Mapping, Distribution and Billing system processing an order according to one embodiment of the present invention.

FIG. 17 is a flowchart for a Tag Information Management Module of a Content Mapping, Distribution and Billing system providing asset details to an Order Management system according to one embodiment of the present invention.

FIG. 18 is a flowchart of a Content Management Module of a Content Mapping, Distribution and Billing system according to one embodiment of the present invention.

FIG. 19 is a flowchart of a Content Delivery and Billing Module of a Content Mapping, Distribution and Billing system according to one embodiment of the present invention.

### DEFINITIONS/GLOSSARY

Prior to a detailed description of the invention(s), the following definitions are provided as an aid to understanding the subject matter and terminology of aspects of the present invention(s), and not necessarily limiting of the invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

Asset: An item that is associated with a television program, identifiable to a viewing consumer, and selectable for purchase or other acquisition.

ATM: Asynchronous Transfer Mode.

ATM: Asset Tag Module.

CDMA: Code Division Multiple Access.

Content: Information, typically in digital form and/or electronic, that may be delivered through a distribution channel.

CMDB: Content Mapping, Distribution and Billing system.

EPG: Electronic Program Guide (also referred to as IPG).

HFC: Hybrid Fiber Coax networks.

HTTP: Hyper Text Transfer Protocol.

IPG: Interactive Program Guide (also referred to as EPG).

IRD: Integrated Receiver Decoder (see also IRT).

IRT: Integrated Receiver Transcoder (see also IRD).

MPEG: Motion Picture Experts Group.

MSO: Multiple System Operators.

OM: Order Module.

OMS: Order Management System.

OMM: Order Management Module.

QAM: Quadrature Amplitude Modulator.

RDBMS: Relational Database Management System.

RF: Radio Frequency.

Settop box: An electronic device connected to a medium of signal transmission, for receiving electronic signals corresponding to television programs and converting the signals into a form for display on a monitor; typically associated with a cable television (CATV) system or a satellite television system. Often includes a programmable digital processor that executes program code that provides special functionality such as interactivity, remote control, pay per view (PPV) functionality, movies on demand (MOD) functionality, gaming, and other types of media features and functions.

SMS: Short Message Service.

Asset Tag: An identifier and/or electronic signature corresponding to a purchasable asset, that uniquely identifies the asset. In accordance with an aspect of the invention, an asset tag is displayed to a television viewer or is otherwise discernible or detectable by a system (e.g. a settop box) to facilitate purchase or other acquisition of the asset. Also Asset.

TIM: Tag Information Module.

UIM: User Interface Module.

UUID: A Universally Unique Identifier is an identifier standard used in software construction, standardized by the Open Software Foundation (OSF) as part of the Distributed Computing Environment (DCE).

VBI: Vertical Blanking Interval.

AML: eXtensible Markup Language 3G: Third generation wireless communication standard.

### DETAILED DESCRIPTION OF THE PREFERRED EMBODIMENT

The present invention is more particularly described in the following examples that are intended as illustrative only since numerous modifications and variations therein will be apparent to those skilled in the art. Various embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

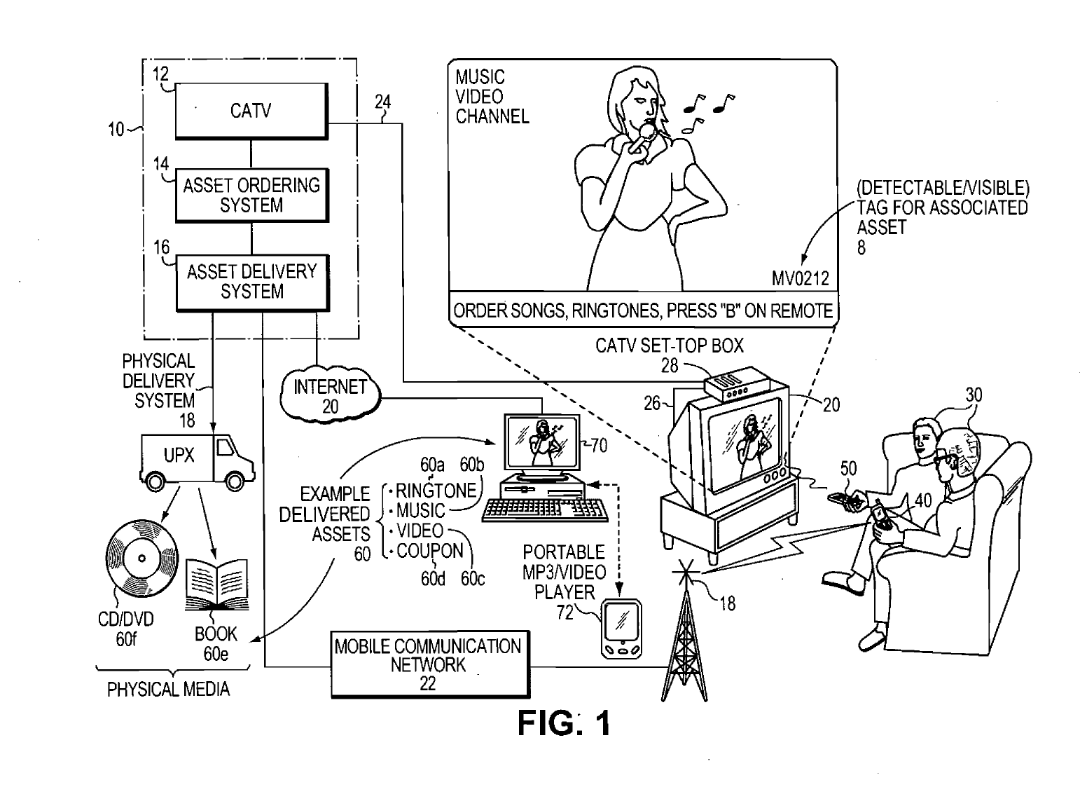

The description will be made as to the embodiments of the present invention in conjunction with the accompanying drawings FIG. 1-FIG. 19. In accordance with the purposes of this invention, as embodied and broadly described herein, this invention, in one aspect, relates to methods and systems for distributing products associated with a television program (“assets”) to consumers such as music, telephone ringtones, videos, CDs, DVDs, and other products that might be associated with the television program.

### System Overview

Referring now to FIG. 1, an overview of an asset distribution system associated with television program is presented according to one embodiment of the present invention. The asset distribution system associated with television program 10 comprises: a cable television system 12, an asset ordering system 14, and an asset delivery system 16. The cable television system 12 provides television shows that the television signal may include an asset tag, or some other form of indications that the asset is available for viewer to purchase. The cable television system includes a settop box 28 which connects to a television set 20 with a cable 26. An application running on the settop box 28 interacts with the viewers 30 so that the viewers can see the prompts about the available assets associated with current program or program segment, can receive additional information about the asset and order the assets with their remote control. The content delivery system 14 comprises at least one database where all assets available for purchase are stored. It may further comprises a plurality of interfaces to a plurality of mobile communication networks 22 with their antennas 18 and interfaces to the internet 20 to deliver ringtones 60a, music 60b, video clips 60c, or electronic coupons 60d, and a physical delivery system 18 to deliver physical media such as CD/DVD 60f, books 60e etc.

When a few viewers 30 are gathering together at a television set 20 watching a television program and they may encounter a certain segment of the program that they really like. They may want to download it and watch/hear it again in a later time on their mobile devices such as a video enabled mobile phone. They also may want to download a segment of sound/music related to the program as a ring tone for their mobile devices. They may also want to get applications, games, wallpapers related to the program to their mobile devices. Here all these audio, sound, music segments, application, games, and wallpapers are generally referred as “assets”. In some occasions, the viewers 30 watch a television commercial and the associated asset is a coupon that can be chosen by the viewers to be delivered to a mobile device as well.

In order to enable television viewers to purchase assets, it is necessary to make an association between the program or program segment and the associated asset. An asset tag identifies one or more assets. An asset tag may or may not contain information that can be directly presented to the viewer. However, given an asset tag, such information may be retrieved. When an asset is available for sale or distribution, the TV screen may show a line of text prompt such as: “Order songs, ringtones, press B on the remote” at the bottom of the screen. The text can be still or scrolling. This line of text prompt can be augmented or replaced with viewer recognizable logos and or other graphics. Generally, the TV screen shows a prompt that an asset or assets are available for purchase. In one embodiment, the prompt is a line of text, either still or scrolling. In another embodiment, the prompt is a viewer recognizable logo. In yet another embodiment, the prompt is a graphic pattern. In yet another embodiment, the prompt is a display on the settop box instead of on the television screen. In a further embodiment, the prompt can be turned on or off at the settop box. Other variations are also possible to those skilled in the art.

If the viewer wants to purchase the asset, he/she uses a remote to order. The TV screen may display some information about the segment such as the asset tag, its author, songwriter, where the asset comes from, the length of the asset, the type of the asset available (audio/sound/music/ringtones), and the price etc. The viewers may also be prompted with purchase information. The viewers are given a choice of purchasing the current asset, or specifying an asset previously shown with an asset tag number. Then the viewers confirm the purchase and the charge is added to the viewers' phone bill or cable bill. The viewers can either download to their own mobile device, or deliver to other people's mobile devices. The viewers are asked to enter a mobile device number for the asset delivery using the remote keypad. The assets ordered will be delivered to the designated mobile device through a mobile communication network, or many other electronic or physical delivery means such as downloading with internet, or shipping with parcel carriers.

This is a very brief overview of the assets distribution system associated with television program without any technical details. A more detailed technical description of the system follows.

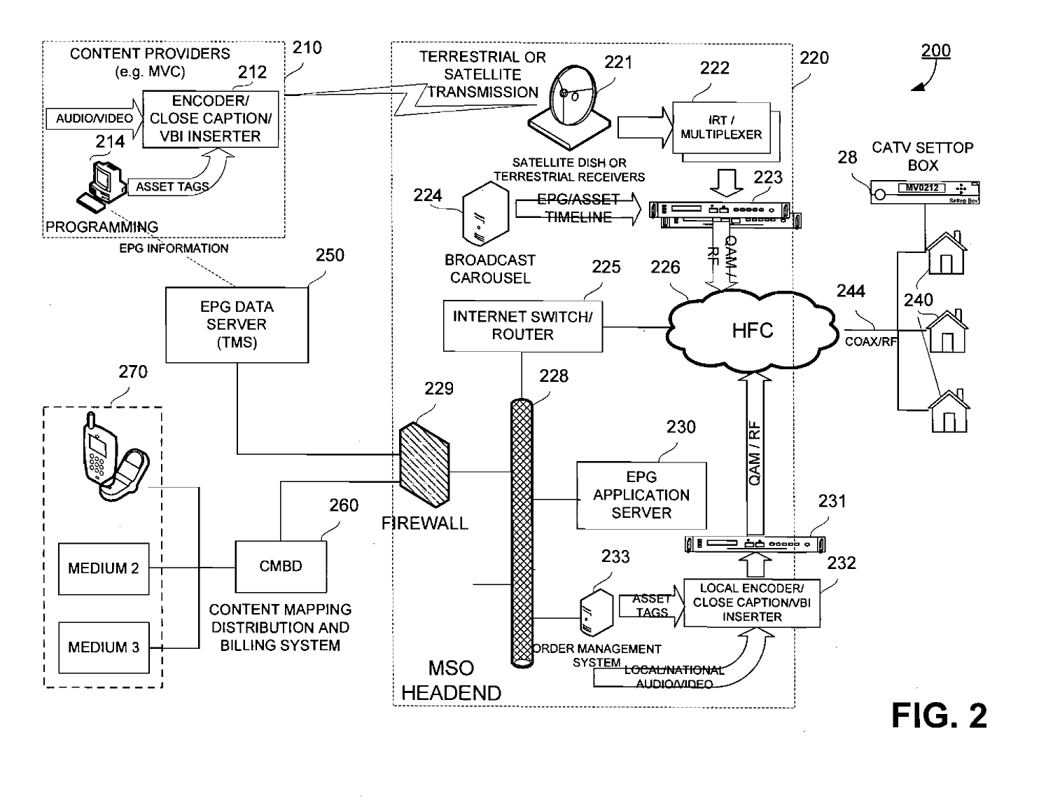

Now referring to FIG. 2, a detailed exemplary system for distributing assets associated with television program 200 is presented according to one embodiment of the present invention. The system comprises: a content provider 210, a multiple system operator (hereinafter “MSO”) headend 220, a plurality of coax/RF cable 244 connecting the MSO headend 220 to a plurality of houses 240 with a plurality of settop boxes 242, an Electronic Program Guide (hereinafter “EPG”) Data Server 250, a central Mapping, Billing, and Delivery (hereinafter “CMBD”) Server and a plurality of devices 270 receiving the distribution of the digital media. The content providers 210 are the original sources of the digital media such as CNN, Cartoon Networks, Disney Channel, and HBO etc. These providers create music, video, and television programs in either audio or video format. If the content providers have the equipment as shown in FIG. 2, an asset tag is inserted into the audio/video signal with an Encoder/Closed Caption or Data Inserter/VBI inserter 212 before the signal is transmitted to the cable operators. The asset tag can be inserted later as well. The programming information 214 is sent to EPG Data Server 250 for inclusion in the EPG.

The original programming with/without asset tag is transmitted to the MSO headend 220 via terrestrial or satellite transmission and it is received by the satellite dish or terrestrial receivers 221 at the MSO headend. When all content providers send their respective audio/video signals to the satellite dish or terrestrial receivers 221 at the MSO headend, they are combined with an integrated receivers transcoder (hereinafter “IRT”)/multiplexer 222, modulated by a plurality of quadrature amplitude modulator (hereinafter “QAM”) 223 and they are then transmitted in a radio frequency (hereinafter “RF”) over a hybrid fiber coax (hereinafter “HFC”) network 226. The broadcast carousel 224 stores and broadcasts the program guide data obtained from the EPG provider. If the asset tag was not added at the original content providers, the asset tag can be inserted with the broadcast carousel 224.

On the other hand, the MSO headend may also receive local or national audio or video feeds from its local broadcasting media such as local ABC, NBC, CBS affiliates, local access or education channels etc. The asset tags from such feeds can be inserted with local encoder/closed caption/VBI inserter 232. Such tag insertion can also be deferred to a later stage at settop box. The local feeds may be combined with a multiplexer 222, modulated by a QAM 223 and they are transmitted in RF over an HFC network 226.

After all television programs are multiplexed into HFC networks in different channels, they are delivered to customers' houses 240 via the coax/RF cable system 244. In each of customer's house 240, there is at least one settop box 242 allowing the viewers to select television show to watch. At this settop box, asset tags can also be detected according to the EPG asynchronously. The asset tag is decoded here and images are superimposed to the television screen so information about an asset tag is shown concurrently with its corresponding program. When a viewer sees a prompt about availability of the assets and decides to purchase the asset, he/she uses his/her remote, presses a designated button and then follows the instructions on the screen to make the purchase. The settop box is specially designed to allow the viewers' interaction. The interaction between the viewers and the settop box includes one or more of the following steps: specifying the asset to purchase, displaying information about the asset specified, displaying the price of the asset, specifying the payment methods, specifying method of delivery, confirming the purchase etc.

When the purchase is made, the order information is encoded at the settop box and transmitted to the Order Management System 233 through the coax/RF cable system and HFC networks, the internet 228 or other similar return communication paths. The order is then sent to a Content Mapping, Distribution and Billing server (CMBD) 260 through firewall 229 for further order processing. The accounting portion of the CMBD 260 collects the fee for the purchase and the charge is added to viewer's either phone bill or cable bill. Other means of payment can also be used such as credit cards, prepaid customer accounts etc. The specific asset purchase is then transmitted from the CMBD 260 to the interface to the delivery networks such as a wireless communication network, internet or other physical delivery mechanism. Finally, the asset purchased is delivered to the mobile device or any other media 270 specified by the purchaser.

### Asset Tag

ASSET TAG: An asset tag is an electronic signature of an asset that uniquely defines the asset. The asset tag is a token that represents an actual asset or a list of assets available for purchase. The asset tag is shared among all entities participating in the ordering process. Its function is similar to that of a barcode for a product seen in a store. It is combined with the segment of audio/video signal electronically, and uses the unused bandwidth of the cable signal such as closed-caption (CC), Motion Picture Experts Group (MPEG), or vertical blanking interval (hereinafter “VBI”). An asset tag may be generated by a central asset tag generation system or a plurality of distributed asset tag generation systems. If the asset tags are generated by a plurality of systems, a method to uniquely generate asset tag values is required. There are many ways used to ensure such uniqueness, most prevalent being the Universally Unique Identifier (hereinafter “UUID”).

ASSET DETAILS: The asset details contain data about the asset (or assets) associated with the asset tags. Depending on the needs, only partial asset details about an asset tag may be available in a given sub-system of the entire system. Each asset in the systems for distributing assets associated with television program contains at least one of the following data: (1) asset tag, (2) asset type (Composite, Ringtone, Wallpaper, Skin, Song, Video, Application, and other . . . ), (3) associated list of asset tags (if asset type is Composite), (4) asset price, (5) asset description (combination of text and graphics), and (6) order manager URL (optional). The asset tag may contain some asset details, however, this is not required. For efficiency, some asset details may be transmitted along with the asset tags. Additional data may be required by different sub-systems and new data can easily be added to the details.

ASSET TAG SCHEDULE: An asset tag schedule contains a list of entries of asset and the associated channel number and program schedule. Logically, each entry in the asset tag schedule contains at least one of following data: (1) asset tag, (2) channel number, and (3) a list of Start time/stop time.

It is important to note that an asset tag may appear multiple times in the schedule for different channel numbers. For optimizing the data transfer between an Order Management System and the Asset Tag Module, the asset tag schedule may be encoded and compressed using many existing methods and techniques.

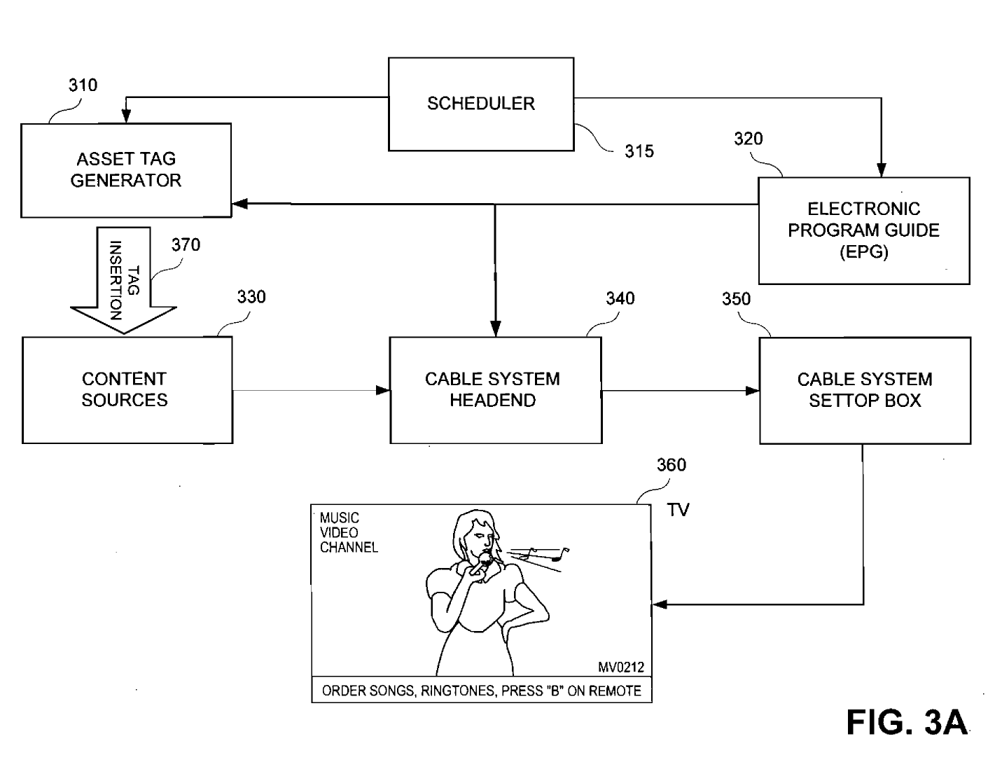

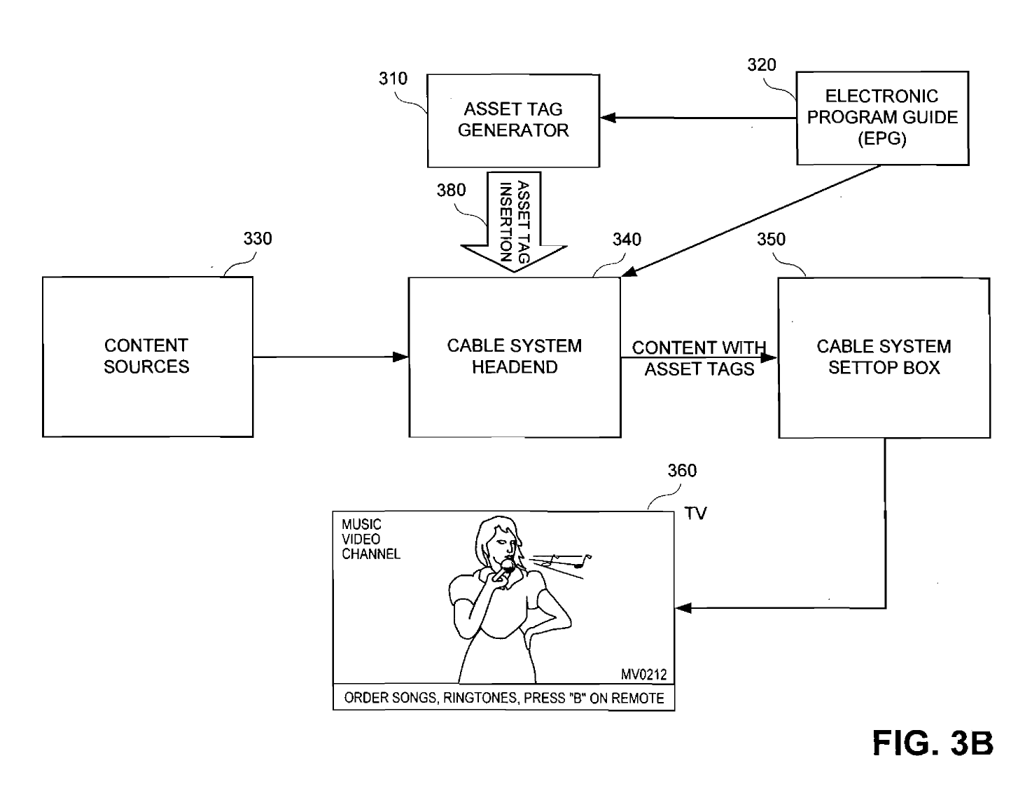

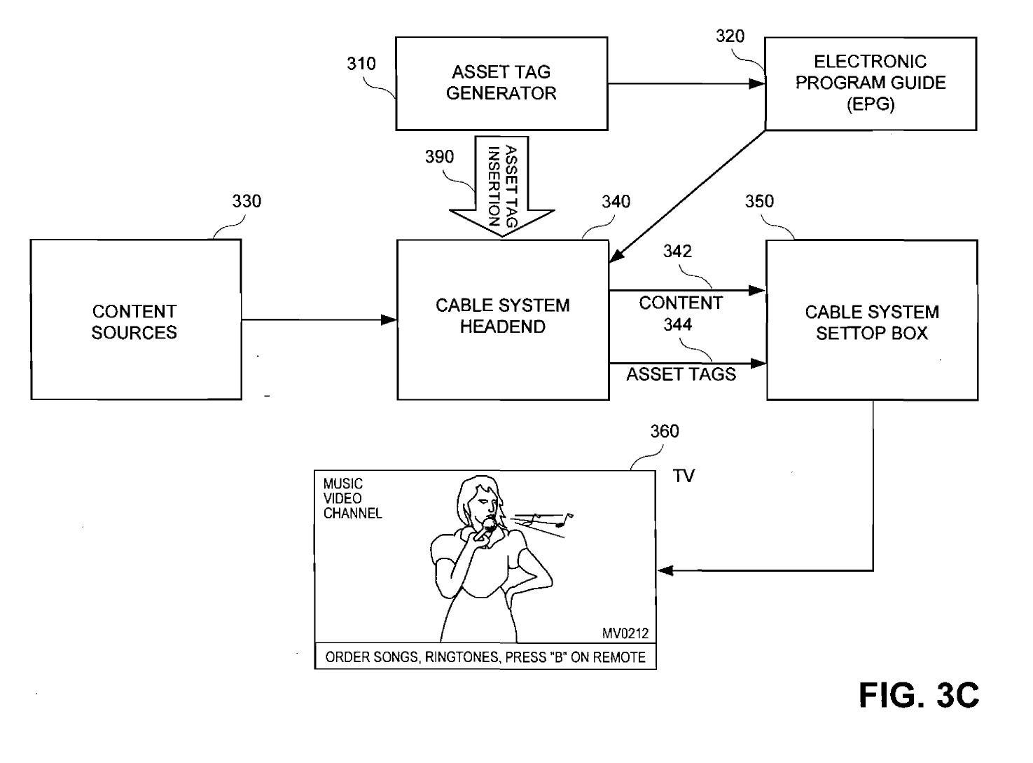

Several methods can be used to generate an asset tag as shown in FIGS. 3A-3C, where the cable environment comprises three major components: a plurality of content sources 330, a cable system headend 340, a plurality of cable system settop boxes 350 and a plurality of television sets 360. The plurality of content sources 330 generates various types of program such as news, entertainment, education etc. These programs include CNN, ABC, NBC, CBS, HBO, Cartoon Networks, and Disney Channel etc. These programs are transmitted from the program source to the cable system headend via terrestrial or satellite. The cable system headend also receives local broadcasting programs from local media. The plurality of content sources 330 and the local broadcasting programs are multiplexed into a radio frequency (RF) signal and sent to a HFC networks and reach the customers' homes. The plurality of cable system settop boxes 350 is used to de-multiplex the RF signal and allows the viewers to select one or more of the channel offered to watch.

The original program signal does not contain any asset tag. However, at the content sources 330, an asset tag can be inserted at the content providers site as shown in FIG. 3A. An electronic program guide EPG 320 is produced with data from a scheduler 315 and the EPG is sent to both the asset tag generator 310 and the cable system headend 340. The Scheduler 315 may send data that may includes programming information about fractions (segments) of a whole program to asset tag generator 310. This fine grained programming information is usually not sent to the EPG 320. Before the content sources 330 air the program, an asset tag generator 310 generates the asset tag and inserts the asset tag into the signal as shown by arrow 370. Then the signal is broadcasted to the cable system headend 340. This method works well with any programs or segments of programs. Some asset details may accompany asset tags for efficient retrieval by the settop application.

Another way to attach the asset tag synchronously is to insert the asset tag at the cable system headend as shown in FIG. 3B. This method is used to insert asset tag into audio/video signal either from content sources or from local sources without asset tags at the cable system headend. During the broadcasting, an asset tag generator 310 generates the asset tag and inserts the asset tag into the signal as shown by arrow 380. Then the signal is multiplexed and broadcasted to the HFC networks. This method works better for shows of large duration (half an hour more). It is difficult to insert asset tags for short segments of programs such as music videos. The asset tag generator 310 uses the same The EPG 320 data as and the cable system headend 340 to ascertain the asset tags are synchronously transmitted along with the content during the broadcast. Some asset details may accompany asset tags for efficient retrieval by the settop application.

The methods disclosed above are synchronous asset tag insertion. The audio/video signals contain the asset tags during the broadcast. An alternative to the synchronous asset tag insertion is to separately download the asset tags, along with associated channels and time periods prior to the broadcast asynchronously and associate with the asset tag based on the program schedule at the settop box of the viewer's home as shown in FIG. 3C. This method is used to associate asset tag with audio/video signal from cable system headend that do not contain asset tags at the settop box. The content 342 and asset tags 344 are delivered to the settop box separately. The asset tags are associated with to the program channel which viewer tunes to and the asset that is purchasable. As with other methods, some asset details may accompany asset tags for efficient retrieval by the settop application.

The asset tag can also be a part of a television programs. For example, the home shopping networks airs a program selling a piece of jewelry. The specific jewelry piece can be marked by an asset tag and if the viewer wishes to purchase this piece, he/she can use his/her remote to purchase the jewelry instead of making phone calls and giving out credit card number. This technique is easily expended to other products such DVD, music CD, books or any other merchandises as long as the programs are marked by their respective asset tags. Present invention encourages impulse spending and allows viewer to purchase the items on the spot while people are exposed to the television market places.

### Settop Application System

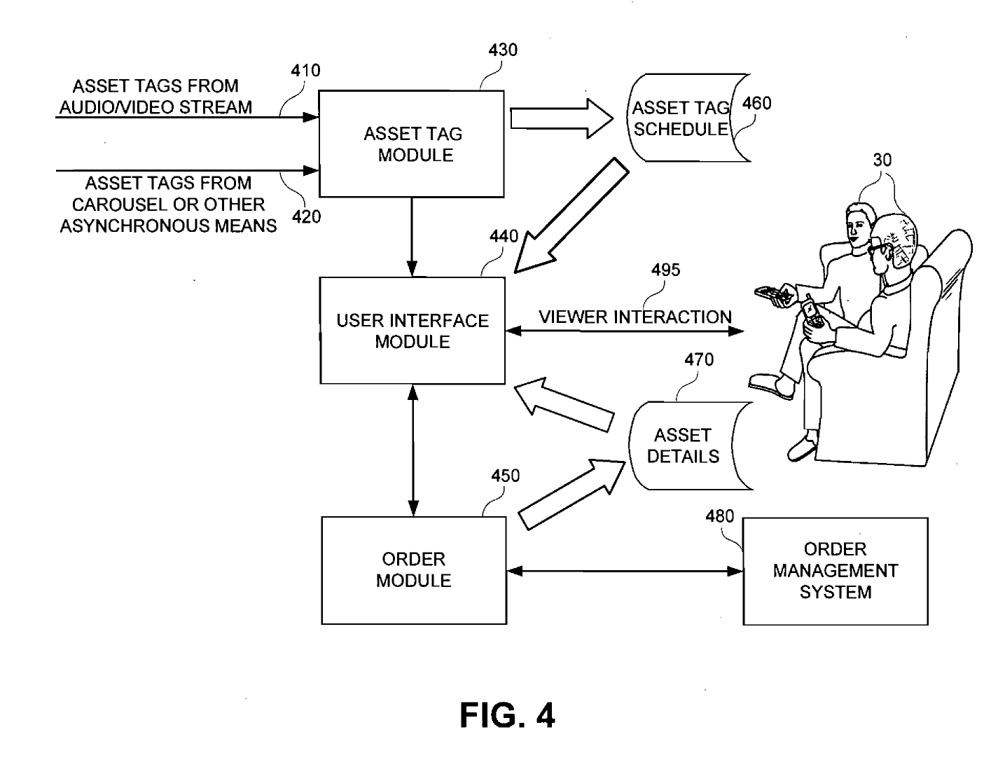

The settop application functionalities comprises three broad categories: (1) identifying and associating asset tags with assets, (2) interacting with the viewer to order an asset, and (3) transmitting and confirming the order. These settop application functionalities may be implemented in many different ways. For the purpose of segmenting functionalities, the settop application is logically divided into three distinct modules as shown in FIG. 4: Asset Tag Module (ATM) 430, User Interface Module (UIM) 440 and Order Module (OM) 450. It is possible to implement the same application functionalities with a different breakup of modules by reducing or combining modules or both. The relationship among the modules is described in FIG. 4. The inputs to the ATM are asset tags from audio/video stream 410 and from carousel or other asynchronous means 420. The ATM extracts necessary information from broadcast carousel and forms the asset tag schedule 460. When asset tags is detected in the program signal or associated from the asset tag schedule 460, the asset tag schedule 460 and the asset tags are fed into the UIM 440 and the viewers 30 interact with the UIM 440 through viewer interaction 495. When the viewers order an asset by using their remote controls, the viewer interaction 495 causes the UIM 440 to transmit the order to the OM 450. The asset details 470 are formed and stored in the OM 450. These asset details are also fed into the UIM 440 so the viewers are able to review the asset details during the viewer interaction. When the viewers confirm the order, the OM 450 interacts with an Order Management System (hereinafter “OMS”) 480 to further process and complete the order.

ASSET TAG MODULE (ATM): The asset tag module is responsible for receiving asset tags and associating program/program segments the viewers are watching with an asset tag. Once the association is made, the asset tag module informs the UIM that an asset tag is available for current program.

The ATM associates asset tags with a program in one of two methods: (1). finding asset tag data from an audio/video signal (method 1), or (2) finding asset tag data from an asset tag schedule (method 2). In order to support method 2, the ATM shall maintain an Asset Tag Schedule (method 3).

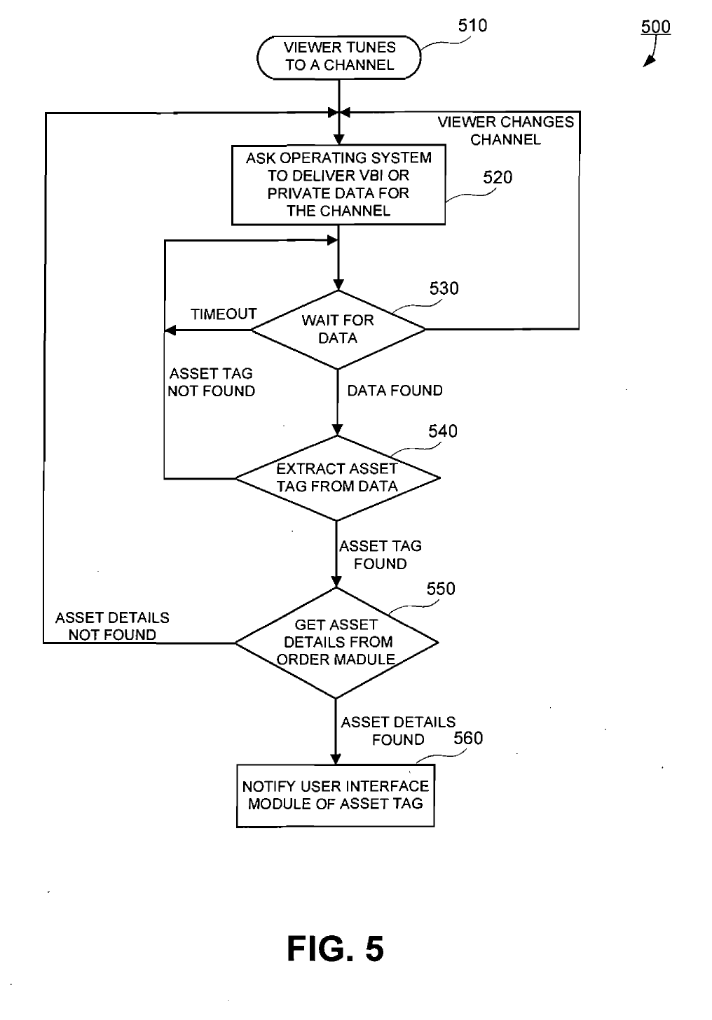

METHOD 1: ATM finds asset tag data from an audio/video stream. A flow chart 500 for this method is shown in FIG. 5 according to one embodiment of the present invention. As a viewer tunes to a particular channel as shown in step 510, the ATM requests the operating system to deliver VBI or private data for this channel as shown in step 520. The ATM waits for data in step 530. If it times out, it goes back to step 530 again and wait for data in a loop. If the viewer changes to another channel, the ATM starts over by requesting the operating system to deliver VBI or private data for the new channel as shown in step 520. If the data is found then the ATM extracts asset tag from the data as shown in step 540. If the asset tag is not found, the ATM will go to step 530 to wait for data again. Otherwise, the ATM retrieves asset details from order module in step 550. If the asset details are not found, the ATM goes back to step 520 to start over again. Otherwise, when the ATM retrieves the asset details in step 550, the ATM notifies the UIM of the asset tag as shown in step 560.

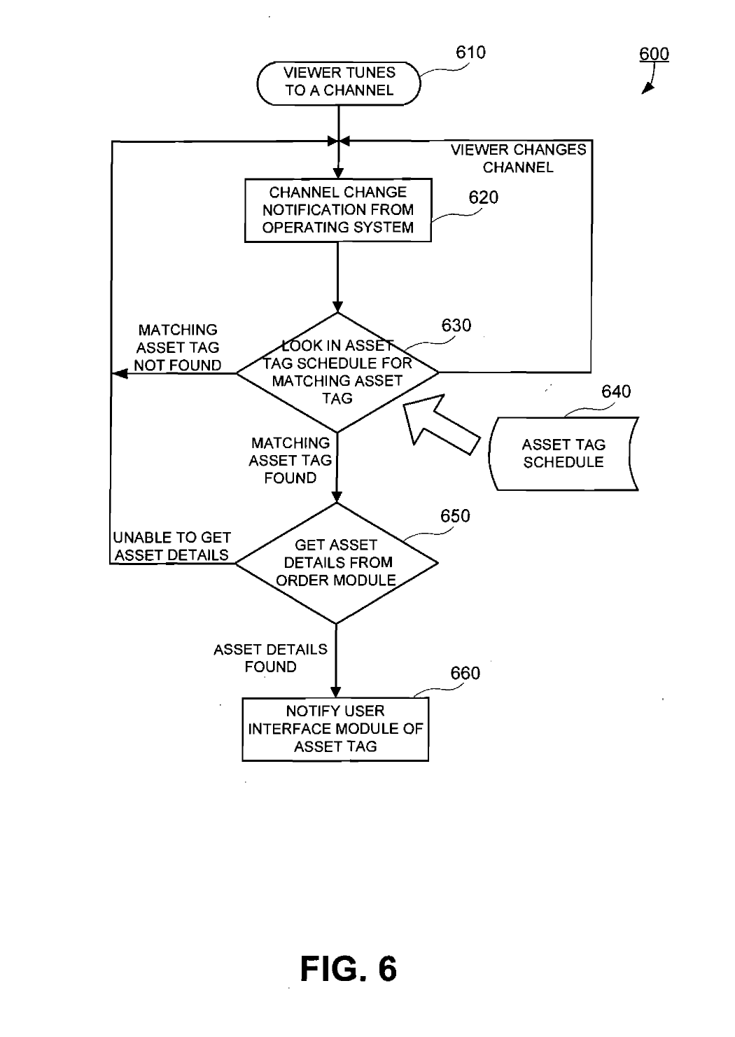

METHOD 2: The ATM finds the asset tag data from an Asset Tag Schedule. A flow chart 600 is shown in FIG. 6 according to one embodiment of the present invention. As a viewer tunes to a particular channel as shown in step 610, the ATM receives a channel change notification from the operating system as shown in step 620. The ATM then looks for asset tag schedule 640 for matching asset tag as shown in step 630. At this time if the viewer changes to another channel, the ATM goes back to step 620 and starts over again. If the matching asset tag is not found the ATM goes back to step 620 and starts over again as well. Otherwise, if the matching asset tag is found, the ATM retrieves asset details from the order module as in step 650. If the asset details are not found, the ATM goes back to step 620 to start over. Otherwise, when the ATM retrieves the asset details, the ATM notifies the UIM of the asset tag as shown in step 660.

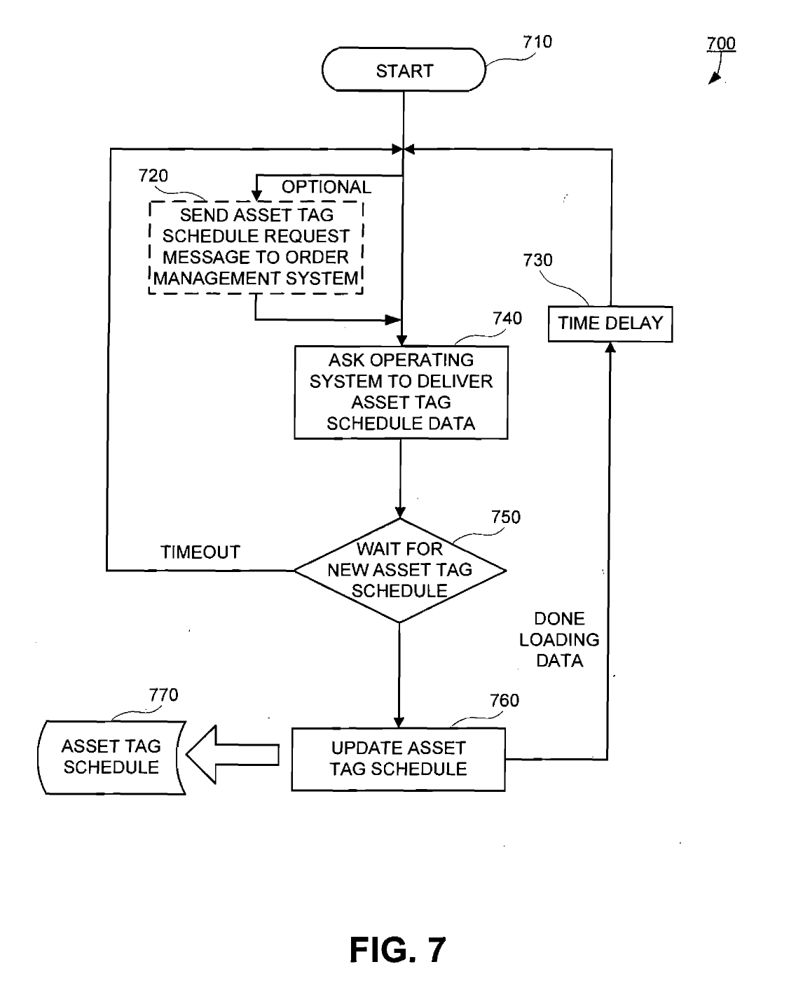

METHOD 3: In order to implement the method 2, the ATM shall maintain an asset tag schedule. A flow chart 700 for maintaining an asset tag schedule 770 is shown in FIG. 7 according to one embodiment of the present invention. At the start 710, the ATM can optionally send the schedule request message to an Order Management System as shown in step 720. Otherwise, the ATM requests operating system to deliver the asset tag schedule as shown in step 740. Then the ATM waits for new asset tag schedule in step 750. If it is timed out, the ATM goes back to 740 and requests operating system to deliver the asset tag schedule as shown in step 740 again. When the ATM receives a new asset tag schedule, the asset tag schedule 770 is updated as shown in step 760.

USER INTERFACE MODULE (UIM): The UIM is responsible for interacting with the viewer for the purpose of: (1) informing the viewers of availability of asset available for purchase; and (2) interacting with the viewers to complete and confirm the order process.

The UIM interacts with the viewers by displaying graphics overlay on the TV screen and receiving input from the viewers by way of keys pressed on the remote control or keypad on the settop box itself. The following steps describe interactions for a sample process of ordering a ringtone for a cellular phone. Many variations of the order confirmation and order item selection are possible and one such scenario is described below.

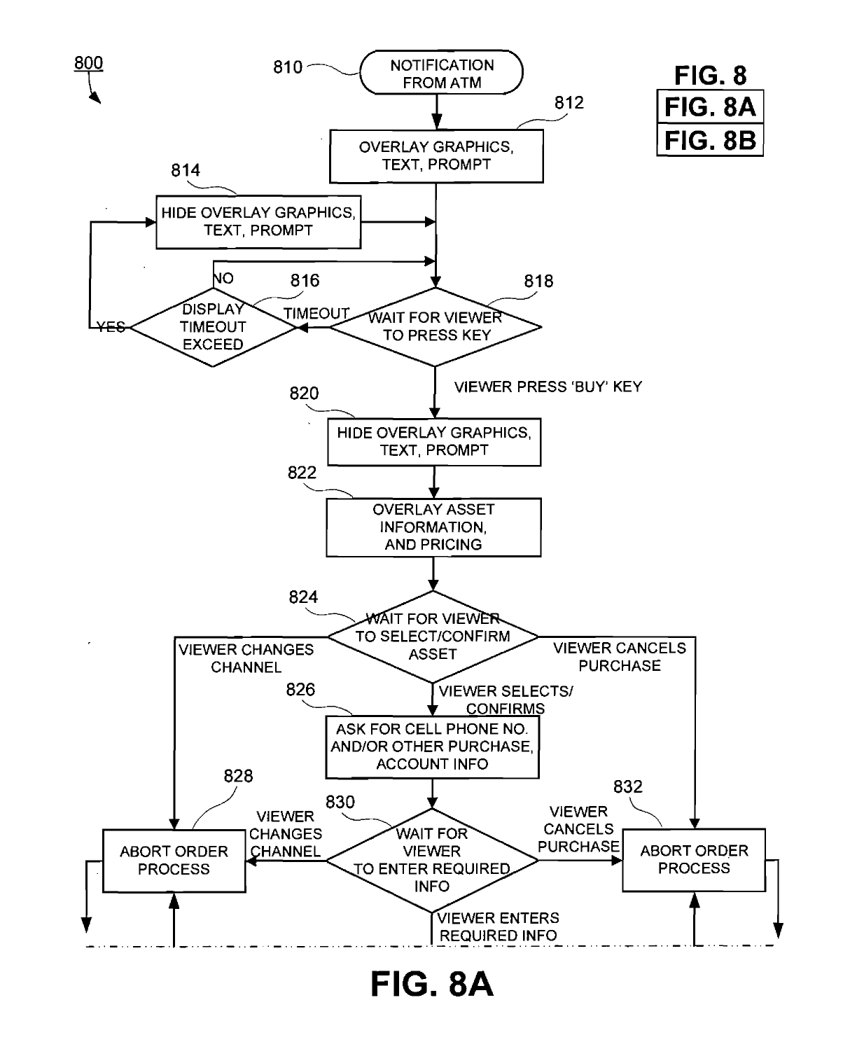

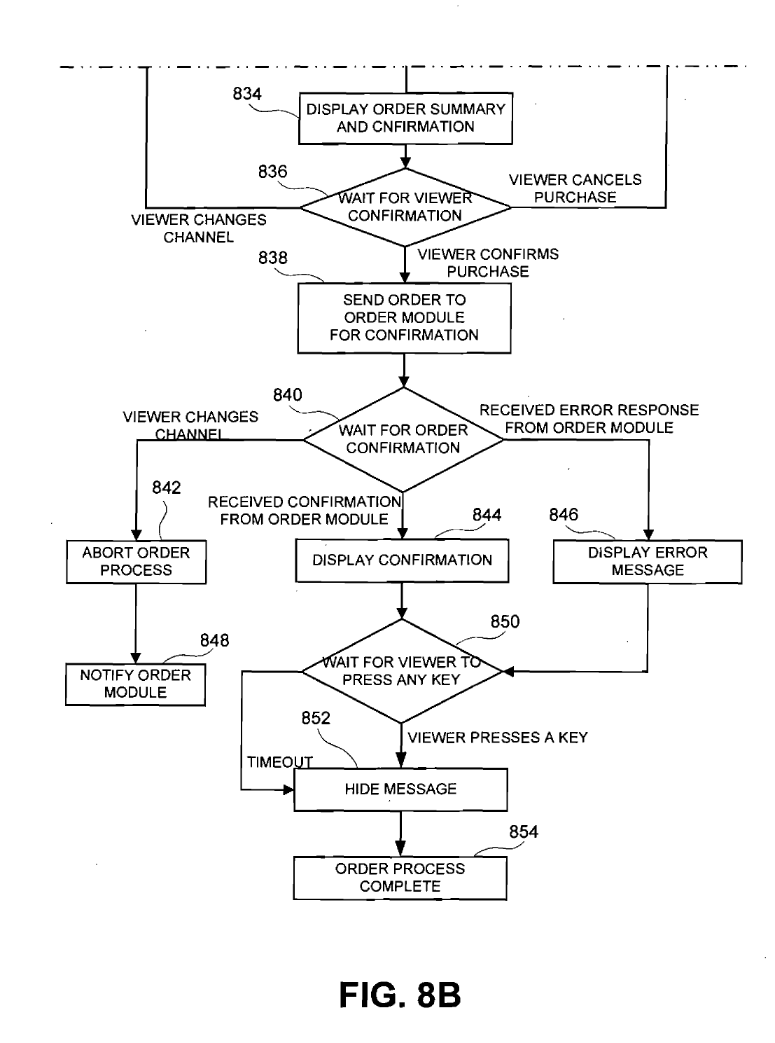

Referring now to FIG. 8, a flowchart 800 for a User Interface Module interacting with a viewer while the viewer is making a purchase is shown according to one embodiment of the present invention.

At the step 810, the UIM receives notification from the ATM that an asset is available for current program showing on the television. The UIM displays a message on the screen to notify the viewer of the availability of the asset (for example, a ringtone) as shown in step 812. The message may read: ‘Press B key to buy the <SONG-NAME> ringtone’ and may contain logos/icons or other graphics in order to emphasize certain aspects (for example, ringtone/sound icon and icon of key to be pressed). Depending on the type of asset, the displayed message may be different.

The UIM waits for the viewer to press a key as shown in step 818. If the viewer does not press any key in a configurable time-out period as shown in step 816, the UIM hides the advertisement message displayed as shown in step 814.

If the viewer presses the required key, the UIM first hides the previous advertisement message as shown in step 820 and displays the description and price of the asset in step 822. The UIM asks the viewer if he/she would like to purchase the asset and the UIM waits for the viewer for response in step 824. If the asset was a composite asset, additional steps for choosing a single asset may be required.

If the viewer chooses to purchase the asset and the asset is associated with a phone number, the UIM prompts the viewer to enter a phone number where the asset is to be delivered in step 826 and waits for viewer's response in step 830. Many variations of viewer entering a phone numbers are possible including picking from previous entries or entering new numbers.

If the viewer changes a channel, or cancels the purchase, the UIM aborts the order process as shown in step 828 and 832. Once the viewer enters all required information, the UIM displays a summary of the order and the entered information in step 834 and waits for the viewer to confirm the order in step 836. If the viewer changes a channel, or cancels the purchase, the UIM aborts the order process as shown in step 828 and 832.

If the viewer confirms the order as shown in step 838, the UIM send a message to the Order Module to complete the order process and waits for the Order Module for order confirmation in step 840. If the viewer changes a channel, the UIM aborts the order process as shown in step 842 and Order Module is notified in step 848. If UIM receives an error message from Order Module, the UIM displays the error message in step 846. Once a notification of order completion is received from the Order Module as shown in step 844, the UIM informs the viewer that the order has been processed and will be delivered to the destination specified during the ordering process and UIM waits for the viewer to press a key as shown in step 850. When the viewer presses any key, or waits long enough to exceed the predetermined timeout period, the UIM hides the message in step 852 and completes the ordering process as shown in step 854.

ORDER MODULE (OM): The OM is responsible for interfacing with the Order Management System to retrieve information about an asset (such as price, description, availability), on request from the UIM. The OM is also responsible for completing the order, upon request from the UIM and informing the UIM of the result of the order process. In order to expedite the viewer experience, the OM may pre-fetch information about anticipated asset tags and associated details in a local cache.

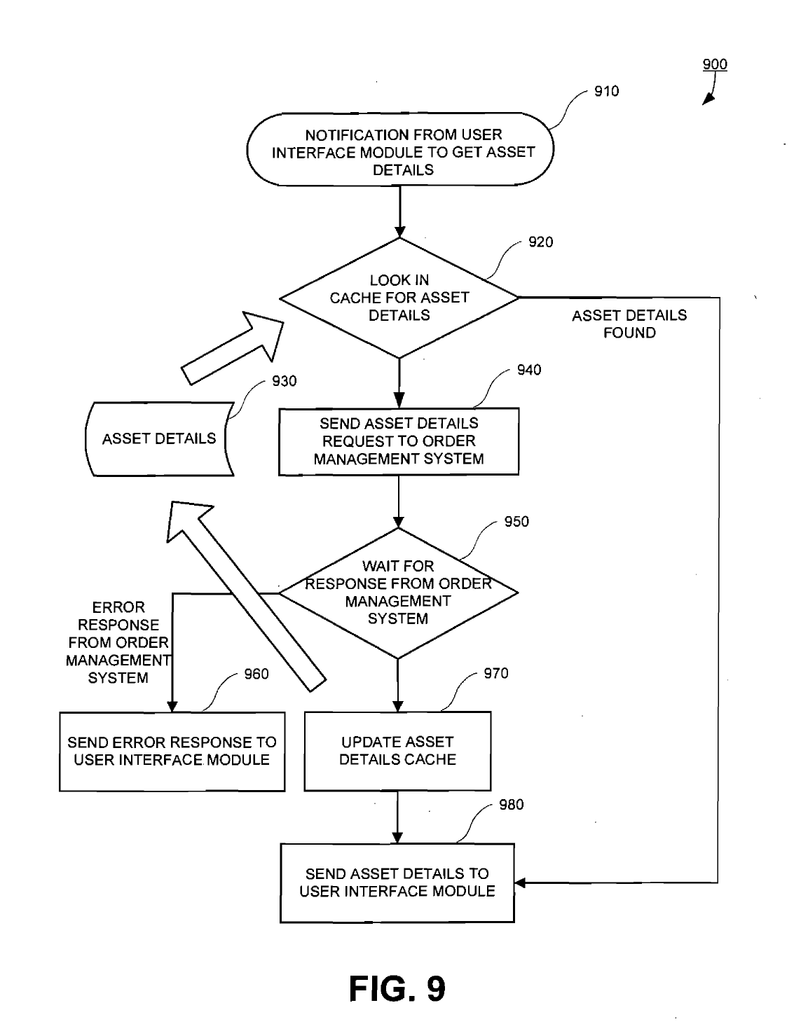

The following steps and FIGS. 9, 10, 11 and 12 describe how the OM interfaces with UIM and Order Management System in the order process. A flowchart 900 for an OM of settop application providing asset details to UIM is shown in FIG. 9 according to one embodiment of the present invention. The OM receives a notification from the UIM to retrieve asset details for an asset in step 910. The OM looks into its cache see if the asset detail information is available in step 920. If the asset detail information is available, it sends it to the UIM in step 980. Otherwise, the OM sends a request to the Order Management System to retrieve the asset details as shown in step 940. The OM waits for response from Order Management System in step 950. When the OM receives the requested asset detail information from the Order Management System, the OM stores/updates the asset details cache 930 in step 970. If an error response is received from Order Management System, the error response is sent to the UIM as shown in step 960.

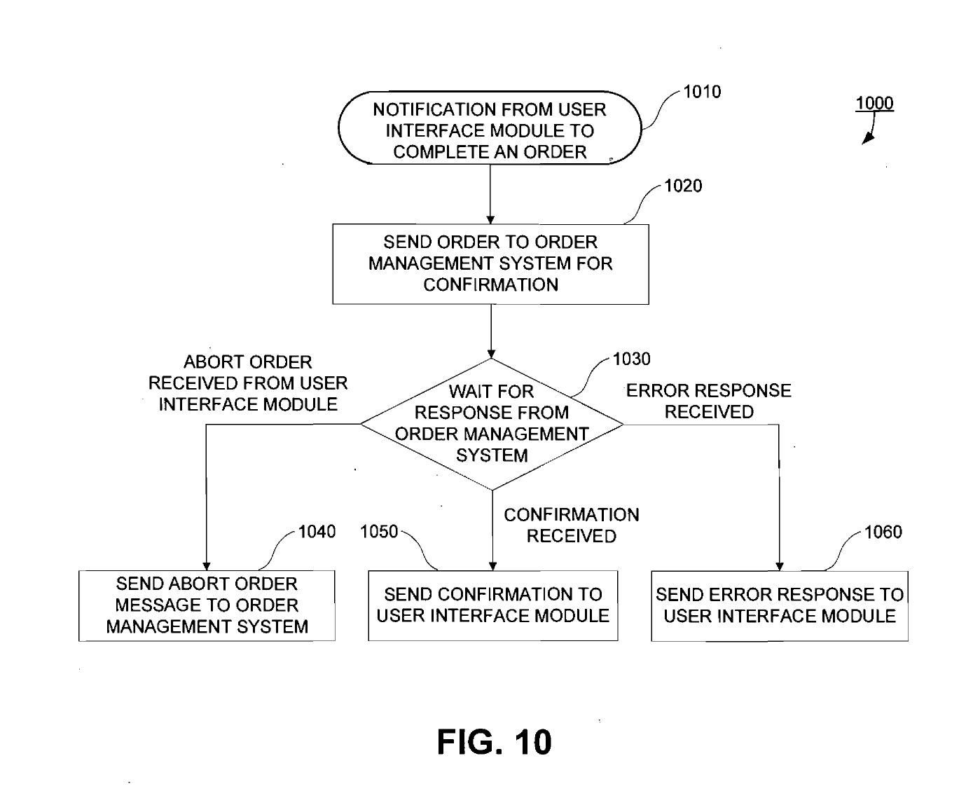

A flowchart 1000 for an OM of settop application processing an order is shown in FIG. 10 according to one embodiment of the present invention. When a viewer confirms an order, the OM receives a message to complete the order from the UIM in step 1010. The OM passes the order to Order Management System for confirmation as in step 1020 and wait for the response from Order Management System in step 1030. If the OM receives a confirmation to the order from the Order Management System, the OM forwards the response to the UIM as shown in step 1050. If the OM receives an error message from the Order Management System, the OM sends the error message to the UIM in step 1060. If an abort order is received from the UIM, the abort order is sent to the Order Management System as shown in step 1040. In some cases, it may be too late to abort the order.

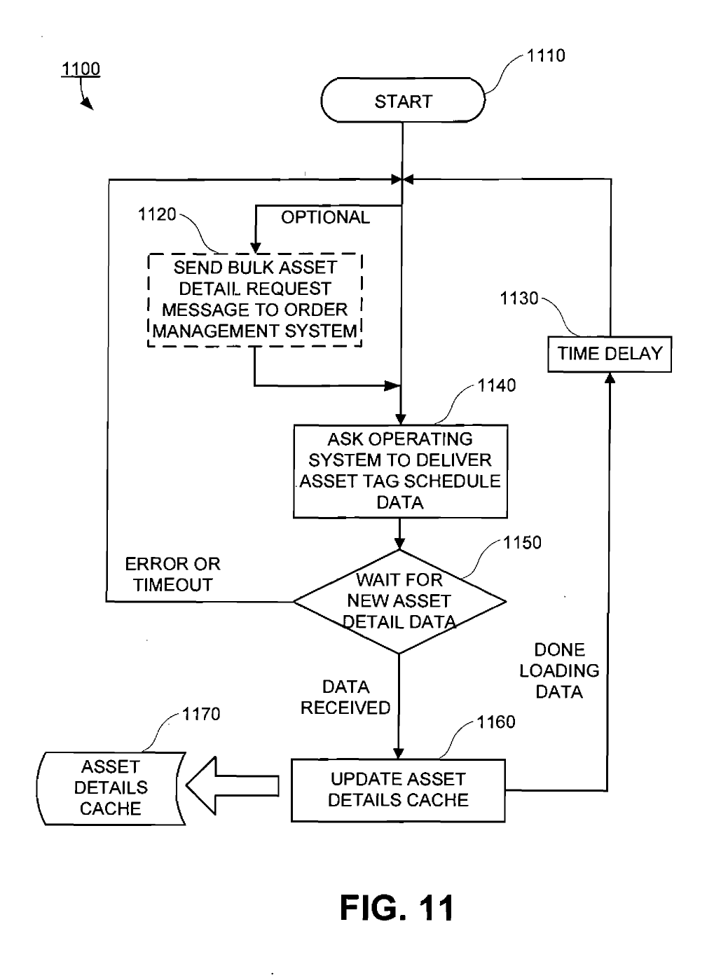

A flowchart 1100 for an Order Module of settop application retrieving asset details in bulk is shown in FIG. 11 according to one embodiment of the present invention. The OM instructs the operating system to deliver asset details data as shown in step 1140 after the start in step 1110. Optionally, an asset detail information request is sent to the Order Management System in step 1120. The data may be sent as a set of file(s) or module(s) on a broadcast carousel or as IP broadcast packets or other similar broadcast mechanism. In advance networks, the data may not be broadcast, but sent to a settop box upon request. The OM waits for the new asset detail data in step 1150. The operating system notifies the OM when asset details data is found. The OM updates the asset details cache 1170 in step 1160. The OM periodically checks the new asset detail information after a predetermined time delay 1130.

### Order Management System

The Order Management System (hereinafter “OMS”) is to act as a gateway between the settop application and the transactions with the Content Mapping, Distribution, and Billing (CMDB) system. The OMS comprises an Order Management Module and a Tag Information Management Module. The major functionalities of the Order Management Module include one or more of following aspects: (1) receiving the order of associated assets from the settop application, (2) forwarding the order with the required information to the Content Mapping, Distribution, and Billing system, (3) receiving the acknowledgement from the Content Mapping, Distribution, and Billing system, and (4) providing the acknowledgement to the settop application.

The major functionalities of the Tag information management include one or more following aspects: (1) receiving the program information from the EPG server, (2) requesting asset tag information from the Content Mapping, Distribution, and Billing system, (3) caching and mapping the asset tag information received from the Content Mapping, Distribution, and Billing system, (4) inserting the asset tag into the video stream via local encoder/closed caption/VBI inserter, (5) receiving request of getting detailed asset tag information of associated assets from the settop application, and (6) providing detailed asset tag information to the settop application.

The OMS listens to requests from either the settop application or from the Content Mapping, Distribution, and Billing system. The interaction between the settop application and the OMS is one to many and the interaction between the OMS and Content Mapping, Distribution, and Billing system is many to many. Thus, each Order Management System has details of the settop applications it is interacting with and each Content Mapping, Distribution, and Billing system has details of all the OMSs they are interacting with. These details are stored in the internal mapping database.

Any standard protocol such as HTTP XML or basic socket management can be used for the underlying communications between the entities. Thus, standard ports for HTTP requests are opened for both settop application and the Content Mapping, Distribution, and Billing system. The OMS can be implemented within the settop application if hardware and cable operator permitting.

ORDER MANAGEMENT MODULE (OMM): The purpose of the OMM is to handle the communication required between the settop application and the Content Mapping, Distribution, and Billing system to fulfill a request for an associated asset to be delivered to the consumer.

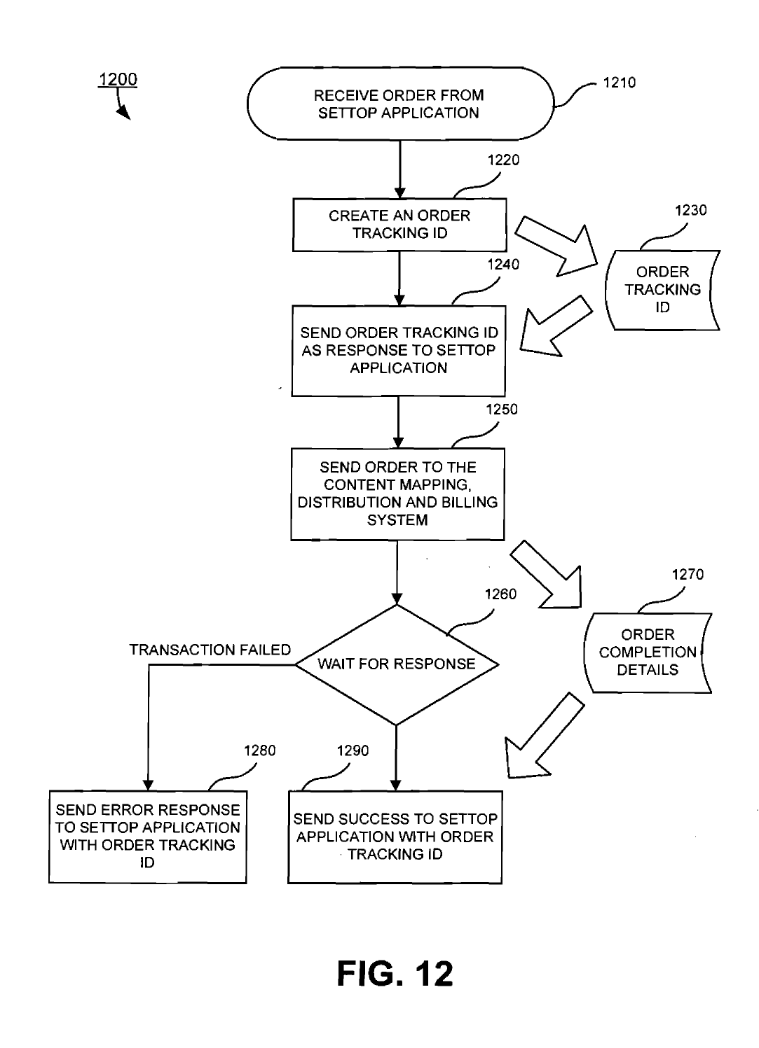

Referring now to FIG. 12, a flowchart 1200 for an OMM of an Order Management System processing an order from a settop application is shown according to one embodiment of the present invention. At the start 1210 the OMM listens for order requests from the settop application as shown in step 1210. The request consists of some or all of following information: (1) associated asset ID requested, (2) details of the OMS where the asset is to be delivered (such as phone number, wireless carrier information (if necessary) for a delivery of asset on a mobile phone or customer ID for a delivery of physical asset via a webstore), and (3) application transaction ID—this can be any unique ID such as the MAC address of the settop box where the settop application is residing as shown in step 1220. The request may contain other details for data collection such as but not limited to: (1) associated program information, (2) sponsor (if any) information, (3) start time of the program, and (4) the request could be for one or multiple bundled associated assets. The Order Management Module maps the Application transaction ID to a unique Order Tracking ID 1230.

The response to the request is the Order Tracking ID 1230 with optionally having other information attached that would be used by the settop application as shown in step 1240 such as: text to be shown on the program (a special thank you note could be provided via this mechanism from a sponsor). The OMM then provides all of the above information to the appropriate Content Mapping, Distribution, and Billing system via a standard request as shown in step 1250. The request has the Order tracking ID 1230 (not the Application Transaction ID). The details of Content Mapping, Distribution, and Billing system where the transaction is to be delivered are determined from the internal mapping database. The response from the Content Mapping, Distribution, and Billing system provides the information 1270 on whether the transaction was completed. This information is stored in the Order Management System. The information 1270 is then provided back to the settop application along with the Order tracking ID in step 1290. If the response received in step 1260 indicates the transaction is failed, the error response is sent to the settop application with it Order Tracking ID in step 1280.

TAG INFORMATION MODULE (TIM): The purpose of the TIM is to have data on associated data regarding upcoming module cached so the settop application can quickly get to this information. The cached data will be based on the program schedule information received either from the settop application of the Content Mapping, Distribution, and Billing system. The TIM will not store any information on the program schedule. There is no bound on what amount of data can be stored and this is left up to each implementation.

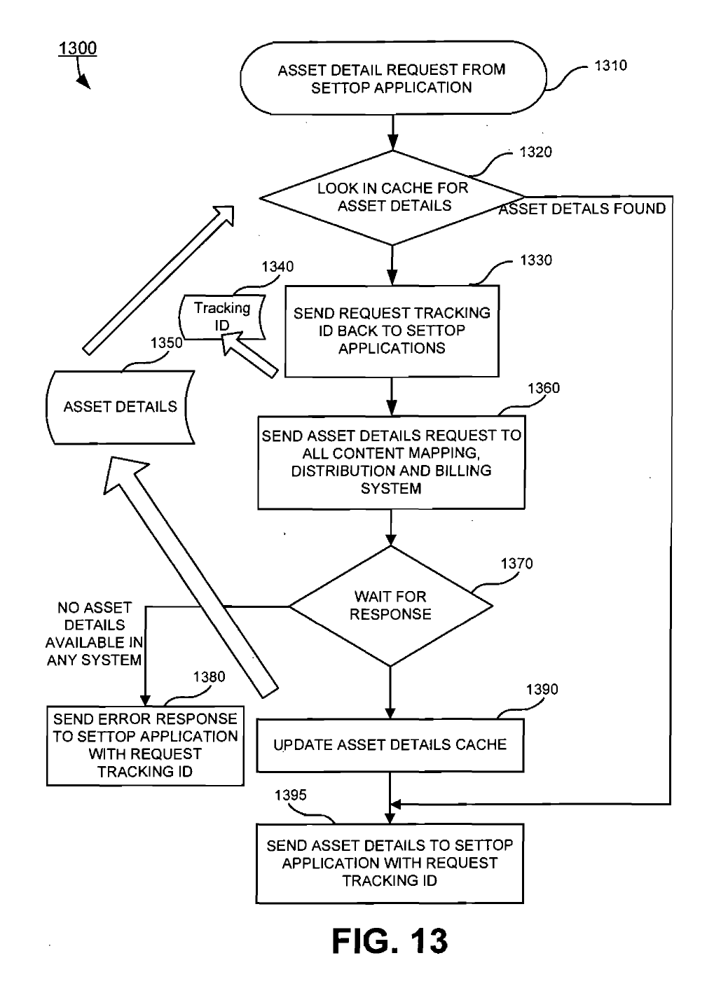

Referring now to FIG. 13, a flowchart 1300 for a TIM of an Order Management System providing asset details to settop applications is presented according to one embodiment of the present invention. In the most basic step, the TIM receives request from a Settop application for asset details for each program as shown in step 1310. The request contains information such as but not limited to asset tag ID and program information. The TIM looks for the following relevant information in the cache as shown in step 1320: asset ID, type of asset, delivery mechanism, and Sponsor (if any) information. The TIM returns the same if the information is found. The asset details are sent to settop application with requested tracking ID as show in step 1395.

If such information is not found, the TIM generates a unique tracking ID 1340 for the request and sends it back to the settop application as shown in step 1330. The TIM then sends the request for asset details to all Content Mapping, Distribution, and Billing systems in its mapping database along with the request tracking ID in step 1360. If all Content Mapping, Distribution, and Billing systems return errors (no asset detail available), the TIM sends the same response to the settop application with the request tracking ID as shown in step 1380. Otherwise, the asset details (which should minimally include the information noted in step 1320) received from the Content Mapping, Distribution, and Billing system are saved/updated in the cache for later use as in step 1390. The Content Mapping, Distribution, and Billing system can use this response to piggyback other asset details for later use. The TIM then sends the asset details to settop application with requested tracking ID as show in step 1395.

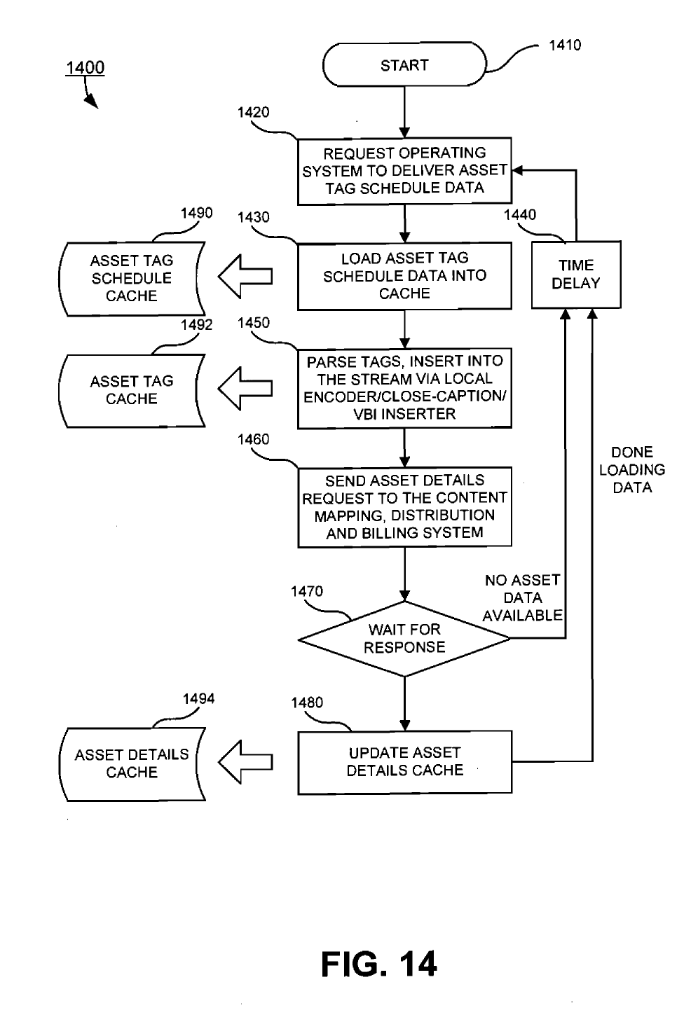

Referring now to FIG. 14, a flowchart 1400 for a TIM of an Order Management System caching asset tag schedule and inserting tags in an audio/video stream is shown according to one embodiment of the present invention. At the start in step 1410, the Order Module instructs the operating system to deliver asset tag schedule as shown in step 1420. The data may be sent as a set of file(s) or module(s) on a broadcast carousel or as IP broadcast packets or other similar broadcast mechanism. In advance networks, the data may not be broadcast, but sent to an EPG server upon request. The operating system notifies the Order Module when asset tag schedule is found. The Order Module loads the asset tag schedule in the cache as shown in step 1430 and the asset tag schedule cache 1490 is updated.

The Order Module parses the asset tag schedule and inserts the parsed asset tags into the stream via local encoder/closed caption/VBI inserter using standard methods as shown in step 1450 and the asset tag cache 1492 is also updated.

The Order Module then sends the request for asset details of all the parsed asset tags to all Content Mapping, Distribution, and Billing systems in its mapping database along with the request tracking ID as shown in step 1460 and waits for response from the Content Mapping, Distribution, and Billing system as in step 1470. If the asset details are not available the Order Module waits for a predetermined time delay 1440 and starts over again at the step 1420. If the asset details are available, the asset details cache 1494 is updated as shown in step 1480. The Order Module repeats this process at a predetermined interval.

### Content Mapping, Distribution and Billing System

The purpose of the Content Mapping, Distribution and Billing (CMDB) system is to hold, manage, deliver and track any type of content with integration of the appropriate billing system. Each media type (mobile, web, etc) where associated assets can be delivered can have a plurality of CMDB systems. For example, a CMDB system CMDB1 could be used to manage and deliver content on mobile phones only on CDMA operators. On the other hand another CMDB system CMDB2 could be use to manage and deliver the content on any web property. Here, the minimal general functionality of any CMDB and a specific implementation for the CMDB for mobile phones are described.

The functionalities of the CMDB system comprise: an Order Management Module, a Tag Information Module, Content Management Module and a Content Delivery and Billing Module. The Order management module is used to: (1) receiving the order of associated assets from the Order Management System, (2) finding the associated assets from the Content Management Module, (3) providing the asset and information to Content Delivery and Billing Module for delivering the content, (4) providing the acknowledgement to the Order Management System, and (5) providing mechanism for tracking the order. The Order Management System can also be integrated in this particular CMDB module and in this case, alternatively, the Order Management Module would directly communicate with the settop box. The Tag Information Management Module is used to: (1) receiving request for asset tag information from the Order Management Module, (2) mapping the asset tags to detailed information of the associated assets, and (3) providing detailed tag information to the Order Management Module. The Content Management Module is used to: (1) providing storage for various type of content such as images, music, ringtones and the associated information such as content name, artist, music label, brand name, and (2) providing a mechanism to search and find content assets from the storage via keywords or/and specific parameters such as content name, artist name. The Content Delivery and Billing Module is used to: (1) providing integration with delivery mechanisms for particular media such as mobile phones, (2) providing integration with billing mechanism for particular media such as charges for mobile delivery on the consumer phone bill. The integration could be with third party billing systems or the party controlling the media such as operator for mobile phones.

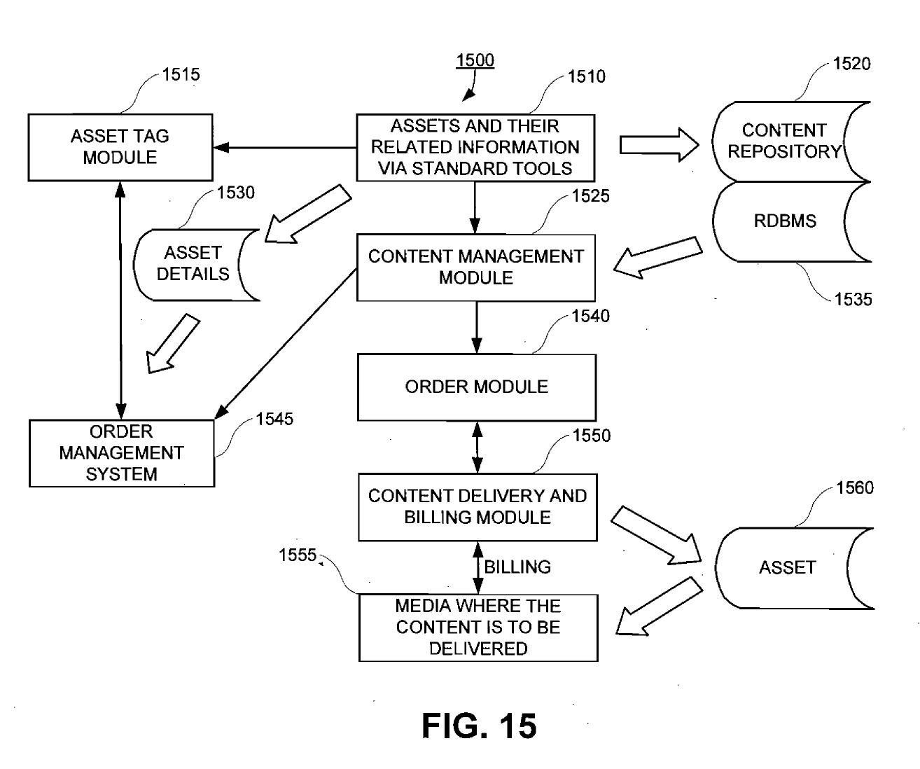

FIG. 15 is a block diagram for a CMDB system according to one embodiment of the present invention. The interaction between the CMDB and the Order Management System is many to many, the interaction between CMDB and the media is one to many. Thus, each order management system has details of the settop applications it is interacting with and each CMDB has details of all the Order Management Systems they are interacting with. These details are stored in the internal mapping database.

Any standard protocol such as HTTP XML or basic socket management can be used for the underlying communications between the entities. Thus, standard ports for HTTP requests are opened for both settop application and the centralized billing and distribution system. In FIG. 15, the Content Management Module 1525 and Asset Tag Module 1515 receive assets and their related information through standard tools 1510. The asset and their related information are also sent to the asset details 1530 and in turn the asset details 1530 are sent to the Order Management System 1545. The assets and their related information are also stored in a Content Repository 1520 in connection with a relational database management system (hereinafter RDBMS) 1535 is sent to the Content Management Module 1525. The Order Module 1540 receives content information from the Content Management Module 1525. The Order Module 1540 also interacts with the Content Delivery and Billing Module 1550. The Content Delivery and Billing Module 1550 deliver the asset 1560 to media where the content is to be delivered as shown by step 1555. Additionally, the Order Management System 1545 interacts also with Asset Tag Module 1515.

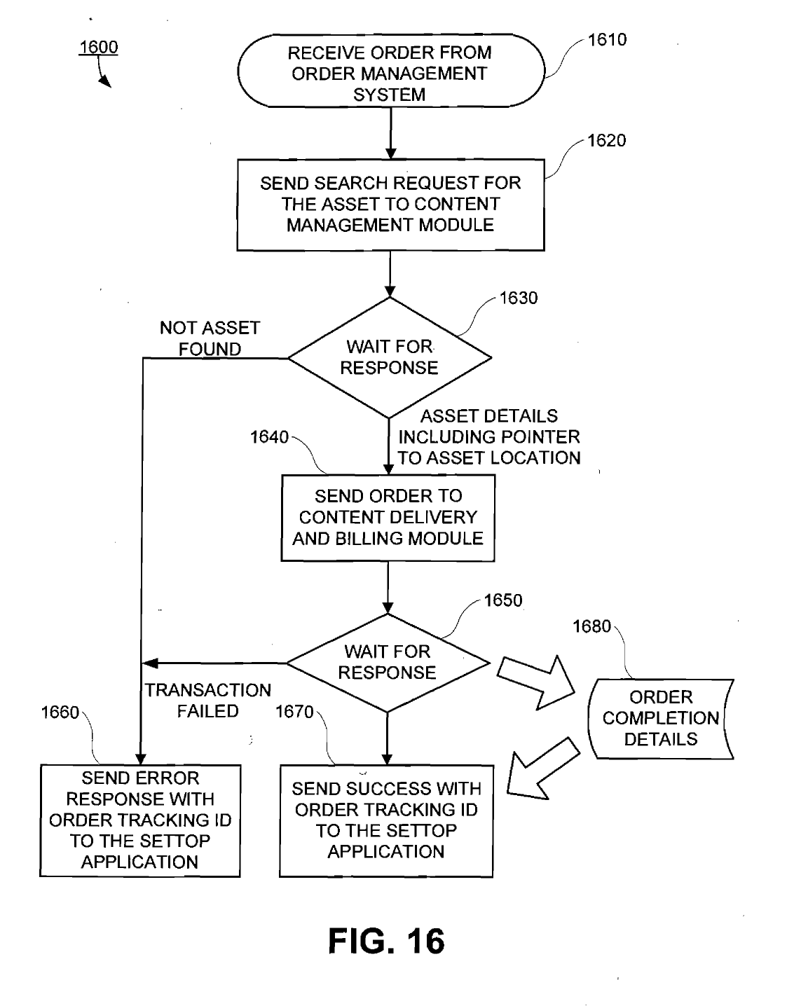

ORDER MANAGEMENT MODULE: The purpose of the Order Management Module is to handle the communication required between the CMDB and the Order Management System to fulfill a request for an associated asset to be delivered to the consumer. Now referring to FIG. 16, a flowchart 1600 for an Order Management Module of a CMDB system processing an order is presented according to one embodiment of the present invention. The Order Management Module listens for order requests from the Order Management System as shown in step 1610. The request comprises one or more of the following: (1) Associated asset ID requested, (2) Details of the system where the asset is to be delivered (such as phone number, wireless carrier information (if necessary) for a delivery of asset on a mobile phone or customer ID for a delivery of physical asset via a webstore), and (3) Order Tracking ID. The request may also contain other details for data collection such as but not limited to: (1) associated program information, (2) sponsor (if any) information, and (3) start time of the program etc. The request could be for one or multiple bundled associated assets. The order module maps the Application Transaction ID to a unique Order Tracking ID. The Order Management Module communicates with the Content Management Module to find the associated asset and receives all the information needed for the delivery of the asset. The Order Management Module waits for the response from the Content Management Module as in step 1630. If no asset is available with an error response, the Order Management Module sends the error response to settop application with the order tracking ID as shown in step 1660. If the asset details are received, the associated asset is then provided to the Content Delivery and Billing Module as shown in step 1640 and then the Order Management Module waits for the response from the Content Delivery and Billing Module as in step 1650. If the delivery or billing fails, the transaction fails and the Order Management Module sends an error message to settop application with the order tracking ID as shown in step 1660. If the transaction is successful with successful delivery and billing, the order completion details 1680 is sent to the settop application with the order tracking ID as show in step 1670.

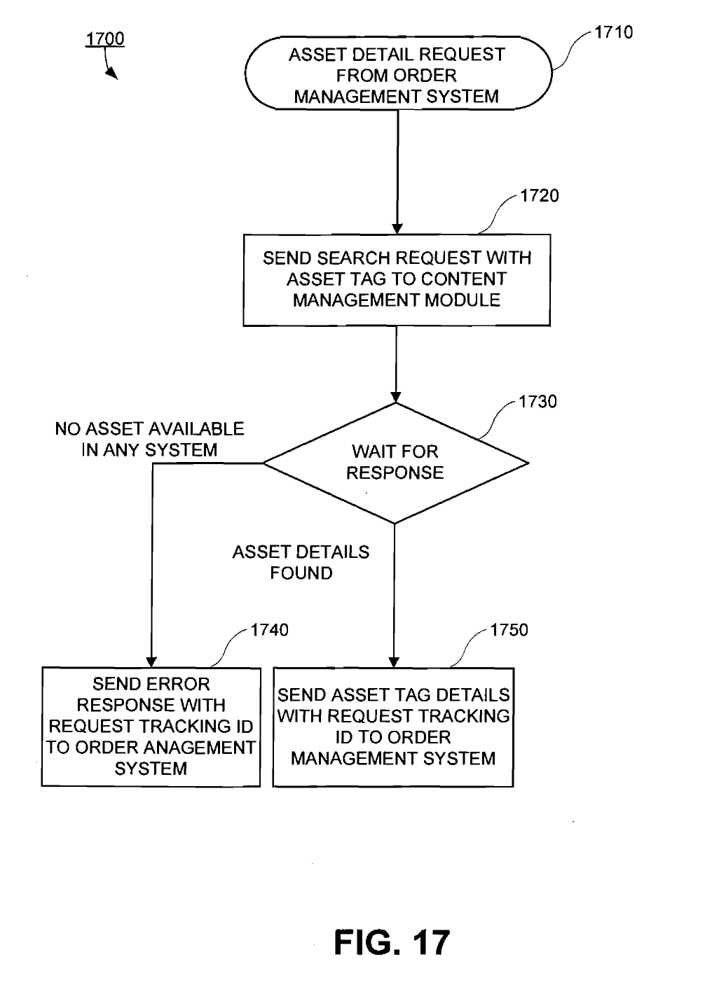

TAG INFORMATION MANAGEMENT MODULE: The purpose of this Tag Information Management Module is to provide data on associated data to the Order Management System. A flowchart for a Tag Information Management Module of a CMDB system providing asset details to an Order Management system is shown in FIG. 17 according to one embodiment of the present invention. The Tag Information Management Module receives request from the Order Management System for asset details for each asset as shown in step 1710. The request contains information such as but not limited to: (1) asset tag ID, (2) program information, and (3) tracking ID. The Tag Information Management Module communicates with the Content Management Module using Search mechanism to find all the associated content based on the above information as in step 1720 and waits for response from the Content Management System as in step 1730. If the Content Management System returns a failure indicating no asset is available in any system, an error response is sent to Order Management System with request tracking ID as shown in step 1740. If the Content Management System returns the asset details successfully, the asset details contain some or all of following information: (1) asset IDs, (2) type of asset, (3) delivery mechanism, (4) parameter (such as phone number) needed from the Order Management System for the successful delivery of the asset, and (5) sponsor (if any) information. The Tag Information Management Module then sends asset detail information to the Order Management Module along with the request tracking ID as shown in step 1750. If other related assets are found by the Content Management Module, they are also returned at this time to the Order Management System.

CONTENT MANAGEMENT MODULE: The purpose of the Content Management Module is to provide means of storing and managing content and related information. The content and related information is stored locally in any standard RDBMS with standard functions such as search. The Content Management Module also provides means of uploading the content into the database. This can be implemented using standard or customized tools with single, batch, online, offline or other similar configurations.

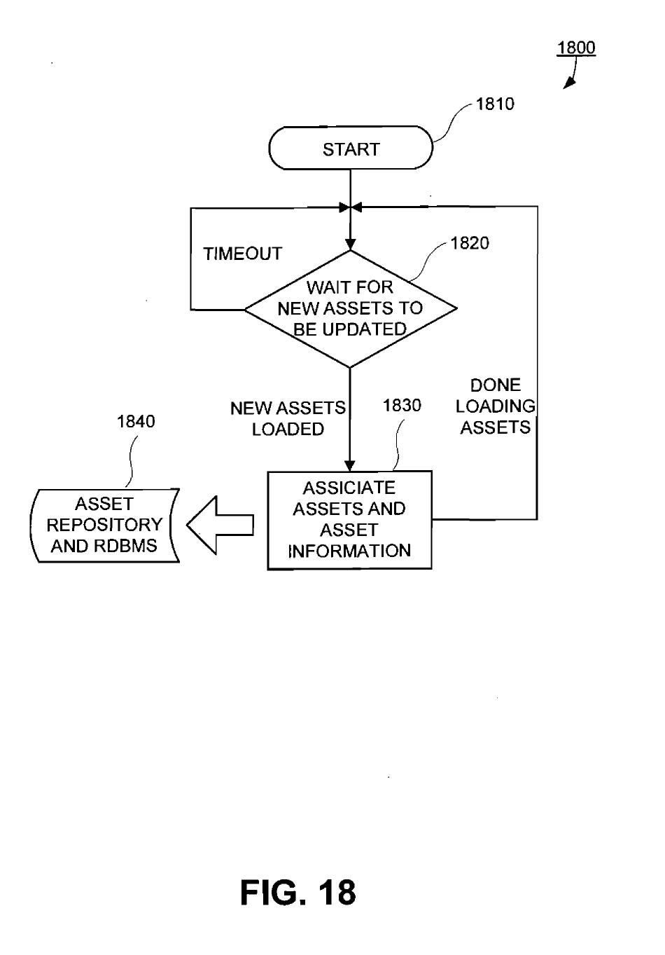

Referring now to FIG. 18, a flowchart 1800 of a Content Management Module of a CMDB system is presented according to one embodiment of the present invention. At the start of step 1810, the Content Management Module waits for new assets to be updated. If a predetermined timeout period expires, the Content Management Module goes back to step 1820 and start a new waiting period. If new assets are loaded, the Content Management Module associates the assets to their asset information as shown in step 1830 and the asset details are sent to the asset repository and RDBMS 1840. The Content Management Module goes back to step 1820 and periodically checks if there is any new asset details updated.

CONTENT DELIVERY AND BILLING MODULE: The purpose of the Content Delivery and Billing Module is to deliver content to the media and invoke the billing mechanism for the transaction. Each medium has its own mechanisms for both assets delivery and billing. The following methods describe the general methods that apply to asset delivery and billing on various media.

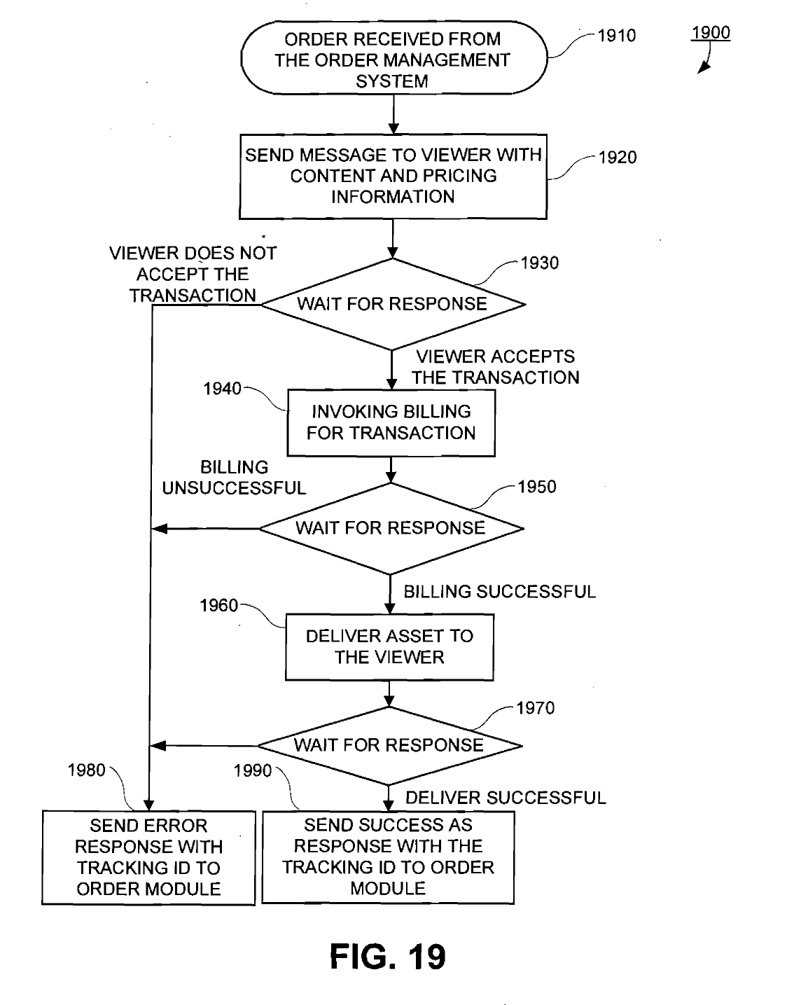

Referring now to FIG. 19, a flowchart 1900 of a Content Delivery and Billing Module of a Content Mapping, Distribution and Billing system is shown according to one embodiment of the present invention. The Content Delivery and Billing Module receives an order from the Order Module as shown in step 1910. The order comprises: (1) order tacking number, (2) asset name, (3) asset pricing, and (4) pointer to the asset location. The Content Delivery and Billing Module provides the asset information such as name, pricing to the viewer via standard means of communication for the media such as Short Message System (SMS) for mobile devices as in step 1920. If the viewer refuses to accept the transaction, an error message is sent to Order Module with the tracking ID as shown in step 1980. If the viewer accepts the transaction, the Content Delivery and Billing Module invokes the billing for this transaction. If the billing fails at step 1950, a billing failure error message is sent to Order Module with the Tracking ID as shown in step 1980. If the billing is successful, the Content Delivery and Billing Module attempts to deliver the asset ordered to the viewer as show in step 1960. If the delivery fails at step 1970, a delivery failure error message is sent to Order Module with the Tracking ID as shown in step 1980. Otherwise, the Content Delivery and Billing Module sends a success response to the Order Module indicating the transaction is completed along with the tracking ID as shown in step 1990.

The foregoing description of the exemplary embodiments of the inventions has been presented only for the purposes of illustration and description and is not intended to be exhaustive or to limit the invention to the precise forms disclosed. Many modifications and variations are possible in light of the above teachings.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing it spirit and scope. Accordingly, the scope of the present invention is defined by the appended claims rather that the foregoing description and the exemplary embodiments described therein.

What is claimed is:

1. A system for ordering and delivering assets associated with a television program represented by a television signal received by a settop box and converted into a form for display to a viewer, comprising:
an asset tag insertion system for inserting an asset tag into a television signal, the asset tag identifying an asset associated with a television program represented by the television signal, the asset being available for purchase or other transaction;
a settop box program responsive to an asset tag contained in the television signal for extracting the asset tag and displaying information corresponding to the asset tag to a viewer;
the settop box program further responsive to a command from the viewer for purchase or other transaction involving the asset for generating an order command corresponding to an order for the asset; and
the settop box program further responsive to communicate the order command to an order management system.

2. The system of claim 1, wherein the assets are selected from the group comprising: digital sound in MP3 format, digital sound in other format, digital video, telephone ringtones, books, CDs, DVDs, coupons, wallpapers, skins, and games.

3. A method for the ordering and delivery of assets associated with a television program represented by a television signal displayed to a viewer, comprising the steps of:
inserting an asset tag into a television signal prior to delivery of the signal to a viewer of the program, the asset tag identifying an asset associated with a television program represented by the television system, the asset being available for purchase or other transaction;
delivering the television signal and inserted asset tag to a television program viewer;
extracting the asset tag from the television signal;
displaying information corresponding to the asset tag to a viewer;
receiving a command from the viewer for purchase or other transaction involving the asset;
in response to the command from the viewer, generating an order command corresponding to an order for the asset; and
communicating the order command to an order management system,
whereby the order management system arranges for a transaction for delivery of the asset to the viewer.

4. The method of claim 3, wherein the assets are selected from the group comprising: digital sound in MP3 format, digital sound in other format, digital video, telephone ringtones, books, CDs, DVDs, coupons, wallpapers, skins, and games.

5. The method of claim 3, wherein the steps of extracting the asset tag, displaying information, and receiving the command are carried out by a settop box.

6. The method of claim 3, wherein the steps of inserting the asset tag and generating an order command are carried out by headend equipment.

7. A television signal settop box that enables a television viewer to order assets associated with a television program represented by a television signal that is processed for display on a television set connected to the settop box, comprising:
a program module operative on the settop box that receives a television signal including an asset tag, the asset tag identifying an asset associated with a television program, the asset being available for purchase or other transaction, and extracts the asset tag from the television signal;
a program module operative on the settop box that provides information corresponding to the asset tag in the video output of the settop box, for display on a television connected to the settop box;
a program module operative on the settop box operative to receive a command from the viewer indicative of a selection of the asset for purchase or other transaction involving the asset, and generating an order command corresponding to selection of the asset for processing by an asset delivery system; and
a program module operative on the settop box for communicating the order command to an order management system.

8. A method for a programmable television signal settop box that enables a television viewer to order assets associated with a television program represented by a television signal that is processed for display on a television set connected to the settop box, comprising the steps of:
receiving a television signal including an asset tag at the settop box, the asset tag identifying an asset associated with a television program, the asset being available for purchase or other transaction
extracting the asset tag from the television signal;
providing information corresponding to the asset tag in the video output of the settop box, for display on a television connected to the settop box;
receiving a command from the viewer indicative of a selection of the asset for purchase or other transaction involving the asset;
generating an order command corresponding to selection of the asset for processing by an asset delivery system; and
communicating the order command from the settop box to an order management system.
